(19) United States
(12) Patent Application Publication
(10) Pub. No.: US 2011/0110794 A1
(43) Pub. Date: May 12, 2011

(54) SENSORS AND METHODS AND APPARATUS RELATING TO SAME

(76) Inventors: Philip Mayleben, Edgewood, KY (US); Buford A. Cooper, Sunman, IN (US); Thomas Stetter, Cincinnati, OH (US)

(21) Appl. No.: 12/944,883

(22) Filed: Nov. 12, 2010

Related U.S. Application Data
(63) Continuation-in-part of application No. 12/617,377, filed on Nov. 12, 2009.

(51) Int. Cl. F04B 49/06; F04B 53/00; G01F 23/26

(52) U.S. Cl. 417/53; 417/313; 73/304 C

(57) ABSTRACT

In one form a capacitive sensor is disclosed for immersion into a fluid, the capacitive sensor having a housing and first and second electrodes with the first electrode being disposed at least partially within the housing and electrically connected to a circuit, the second electrode being electrically connected to the circuit via an electrical connection and physically separated from the housing containing at least a portion of the first electrode so that at least a portion of the electrical connection or second electrode is located above or outside of the fluid to reduce the risk that minerals will form between the electrodes. In another form the electrodes are separated into their own cavities of the sensor housing via a bridging member which separates the electrodes to help reduce the risk of mineral buildup occurring between the electrodes. In other forms, capacitors, capacitive sensors, pump controls and systems utilizing these features are disclosed along with methods and apparatus relating to same. In yet other forms additional sensors such as current sensors, thermal sensors, speed sensors, torque sensors and Hall Effect sensors are disclosed for use alone or in combination with said capacitive sensor for detecting fluid level and/or controlling pumps. In still other forms, apparatus and methods relating to self cleaning pumps are disclosed.

### CROSS-REFERENCE TO RELATED APPLICATION

This application is a continuation-in-part of prior U.S. application Ser. No. 12/617,377, filed Nov. 12, 2009, which is hereby incorporated herein by reference in its entirety.

### FIELD OF THE INVENTION

The present invention relates to sensors and methods and apparatus relating to same. More particularly, the present inventions relates to capacitors, capacitive sensors, pump controls, pump systems and methods relating to fluid control and/or fluid level monitoring and/or control.

### BACKGROUND OF THE INVENTION

Sensors are needed for a variety of applications. For example, pump applications, such as sump, dewatering, sewage, utility, effluent and grinder pumps, can use sensors to determine when the pump should be turned on and/or turned off. Conventional sump pumps generally include a pump having a mechanical switch connected to a float mechanism for controlling a liquid level in a reservoir. The float mechanism is disposed within the reservoir and adapted to travel on the surface of the liquid as the liquid rises and falls. Typical float mechanisms are mechanically connected to the switch and according to the position of the float relative to the pump, the switch controls power to the pump.

In one configuration, the mechanical connection between the switch and the float includes a flexible tether. As the float travels up or down on the surface of the liquid in the reservoir, the orientation of the flexible tether relative to the switch changes. Another typical form of a float mechanism includes one or more rods or interconnected linkages. Similar to the tether, the rods or linkages are configured to allow the float to travel freely with the rising or falling of the surface of the liquid in the reservoir. In either of these configurations, once the float reaches a predetermined upper limit, the tether, rod, or linkage transfers a mechanical force to flip the switch, thereby completing the circuit and activating the pump. Conversely, when the liquid level and the float reach a predetermined lower limit, the tether, rod, or linkage transfers a mechanical force to the switch in an opposite direction, thereby interrupting the circuit and deactivating the pump.

A shortcoming of the above-described sump pump float switch mechanisms is that they are inclined to experience mechanical failure. Sometimes mechanical failure occurs due to a deterioration of the mechanical connection between the float and the switch. Other times, the mechanical failure may occur due to objects in the reservoir that restrict or hinder the proper operation of the float mechanism.

A further known sump pump switching mechanism includes a resistance switching mechanism. Resistance switching mechanisms include a pair of electrodes exposed in the liquid in the reservoir. As the level of the liquid in the reservoir changes relative to the electrodes, the electrical resistance between the two electrodes changes. Based on the change in resistance between the two electrodes, a controller activates or deactivates the pump. A shortcoming of resistance type switch mechanisms is that the electrodes are exposed to the liquid and tend to be vulnerable to corrosion. Once corroded, the electrodes fail to generate accurate resistances that the controller expects and the controller fails to operate properly.

A still further known sump pump switching mechanism includes a capacitance switching mechanism. Capacitance switching mechanisms generally include a controller, an upper capacitor having two electrodes, and a lower capacitor having two electrodes. The upper and lower capacitors operate substantially independent of each other. When the level of the liquid reaches the upper capacitor, the controller detects a capacitance across both capacitors and activates the pump. The controller continues to activate the pump as the level of the liquid in the reservoir drops. Once the level of the liquid drops below the lower capacitor, the controller detects no capacitance across the lower capacitor and deactivates the pump. One shortcoming of such capacitance-based switching mechanisms is the reliance on multiple capacitors. Failure of one of the upper and lower capacitors may detrimentally affect the proper operation of the entire sump pump.

In other known sump pump applications, magnetic switching mechanisms, such as Hall Effect sensors or switches, are used to detect water levels and operate a pump. For example, in some applications, a float is used to raise a magnet to an upper magnetic sensor at which point the pump is turned on. When the water level drops the float descends down to a lower magnetic sensor at which point the pump is turned off. A shortcoming of such magnetic sensors is that they again require moving parts and are inclined to experience mechanical failure, such as that discussed above with respect to tethers.

Accordingly, it has been determined that a need exists for an improved sensor and method and apparatus for controlling a pump using same which overcome the aforementioned limitations and which further provide capabilities, features and functions, not available in current sensors and pumps.

### SUMMARY OF THE INVENTION

In one form the present invention provides a variable capacitor having first and second electrodes and a dielectric connecting the first and second electrodes to form a capacitor having a readable capacitance. The dielectric includes a first part made of an insulative material and a second part made of a liquid that changes levels with respect to the insulative material which causes a change in the capacitance of the capacitor. Thus, the changing liquid level with respect to the insulative material provides a variable capacitor capable of producing a plurality of different capacitances.

In another form, the invention provides a capacitive sensor having a capacitor at least partially immersed in a liquid having a level that changes in relation to the capacitor, with the capacitor having a variable capacitance depending on the level of the liquid for providing a capacitance reading associated with the liquid level as mentioned above, and a circuit connected to the capacitor to determine the capacitance of the capacitor. Thus, the level of the liquid within which the capacitor is immersed may be determined based on the capacitance of the capacitor and the sensor may be used with a number of different pieces of equipment that are to be operated in response to changing liquid levels.

For example, one aspect of the present invention provides a pump controller for controlling the level of a liquid in a reservoir. The pump controller includes a controller and a capacitor. The capacitor is adapted to provide a first capacitance to the controller when the liquid in the reservoir reaches a first predetermined level relative thereto. Additionally, the capacitor is adapted to provide a second capacitance to the controller when the liquid in the reservoir reaches a second level relative thereto. Based on the second capacitance, the controller determines when to deactivate the pump.

One advantage of this form of the present invention is that it requires no moving parts that may suffer mechanical failure. The apparatus serves as a solid state sensor that detects liquid level to control activation and deactivation of the pump. Another advantage of this form of the present invention is that the capacitor may be wholly contained within the pump controller. Thus, the electrodes of the capacitor do not have to be exposed to the liquid in the reservoir and, therefore, would not be vulnerable to corrosion such as the electrodes in prior known resistance-based devices. A further advantage of this pump controller is that it includes a single capacitor in communication with the controller. This overall design reduces the number of electrical, mechanical, or electro-mechanical components that may suffer failure, makes it easier to assemble the sensor and can reduce cost associated with assembly and/or material costs for the apparatus.

In another form, the controller determines a run-time based on the second capacitance detected by the controller for which the pump should be activated to move a predetermined amount of the liquid out of the reservoir. For example, the controller may determine the flow rate of the liquid out of the reservoir based on the difference in capacitance readings from the time the pump was activated (e.g., the first capacitance reading) to the time the second capacitance reading was taken and calculate how much longer the pump needs to remain operating at that flow rate in order to lower the liquid level in the reservoir to a desired level.

In another form, the controller may be configured to deactivate the pump upon detecting the second capacitance from the capacitor. For example, the controller may be setup to regularly, or even continually, monitor the capacitance reading from the capacitor and shut off the pump once a predetermined capacitance value has been reached because the predetermined capacitance value is indicative of the fact the liquid level in the reservoir has dropped to a desired level. In one form, the apparatus includes a power source generating an alternating current and the controller is configured to detect the capacitance of the capacitor (or data associated with same) each time the alternating current is at a zero-crossing. In another form, the apparatus continually monitors the capacitance reading from the capacitor (or data associated with same).

In yet other forms of the invention, a variable capacitor, capacitive sensor and/or pump control is/are provided having an external electrode or probe for detecting capacitance in environments having highly conductive fluids or fluids with highly conductive minerals therein, such as for example sewage applications or other pump applications where conductive materials such as minerals can form between the capacitor electrodes. The remote positioning of the electrode or probe reduces the likelihood that conductive particles will collect between the terminals and thereby affect the ability of the capacitor, sensor and/or pump control to accurately measure capacitance based on the level of fluid making up at least a portion of the dielectric. Methods relating to the operation and use of such capacitors, sensors and pump controls are also disclosed herein.

In another form a first type of sensor, such as a capacitive sensor, is used to trigger operation of a device, such as a pump, and a second different type of sensor, such as a current sensor, thermal sensor, speed/torque sensor or Hall Effect sensor, is used to either shut off the device or determine how long to operate the device. For example, in one form, a pump system is disclosed in which a capacitive sensor is used to turn on a pump to evacuate a fluid from an area and a current sensor is used to determine when to shut the pump off. Methods relating to the operation and use of such a two-sensor system are also disclosed herein.

In a different form, a capacitor, capacitive sensor, pump control and/or pump system is/are disclosed in which the electrodes of the capacitor are contained within the same housing, but are separated from one another via a bridging member to help reduce the risk of mineral buildup between the electrodes. In a preferred form, the bridging member is designed to generally remain above the fluid within which the capacitive electrodes are immersed so that salt bridging or other mineral buildup cannot occur between the electrodes. In addition, the first and second cavities are defined by an inner or interior wall and the housing further comprises an outer or exterior wall that surrounds at least a portion of the first and second cavities and is spaced apart from the interior or inner wall to provide a protective gap between the inner and outer walls and protect the components within the first and second cavities from damage during validation testing or general use of the capacitor, capacitive sensor, pump control and/or pump system.

The pump control and system may also be configured with a current sensor that is used to detect when the pump is to be deactivated. In one form, the current sensor may simply monitor current and shutoff the pump when a predetermined current is detected either once or over a plurality of times or when an average of current readings has reached a predetermined current level. In some forms these readings may be of specific current levels, while in other forms the readings may simply be of any values above or below predetermined thresholds. In another form, the current sensor may be used to signal when a pump malfunction or repair or maintenance condition exists, such as a high current condition. The signaling may involve cycling on and off the pump via the pump control when a high current condition has been detected, in an effort to dislodge or breakup an obstruction or blockage hindering the operation of the pump. In other forms, the signaling may involve the actuation of a visual and/or audible alarm to indicate a malfunction, such as a light or indicator of some form or a buzzer or speaker of some type. In still other forms, the signaling may involve transmitting a signal via circuit, network or wirelessly to alert of the malfunction. In still other forms, the signaling may simply comprise disabling or turning off the pump when the malfunction has been detected, or any combination of the above mentioned signals.

In other forms of the invention a self cleaning pump or pump system is disclosed in which a stream of fluid is used to flush or clean any of the above mentioned capacitors or capacitive sensors and pumps or pump controls using same. In a preferred form, the pump itself is used to produce the fluid stream and the sensor is positioned in alignment with the fluid stream so that the fluid stream may clean the sensor to assist in keeping the capacitor, sensor, pump control or system operating properly and/or to reduce the risk of mineral buildup between the electrodes of the capacitor or sensor. In some forms the alignment results in the fluid stream directly contacting a surface of the sensor and in other forms the alignment results in the fluid stream indirectly contacting a surface of the sensor after having contacted some other surface first. In still other forms, a plurality of fluid streams are used to clean the capacitor or sensor.

Methods relating to all of the aforementioned concepts are also disclosed herein.

### BRIEF DESCRIPTION OF THE DRAWINGS

The invention will be explained in exemplary embodiments with reference to drawings, in which:

FIG. 1 is a side view of a first embodiment of a sump pump system disposed within a reservoir and incorporating a sensor unit in accordance with one form of the present invention;

FIG. 2 is a side cross-sectional view of the sensor unit of the first embodiment of the sensor unit depicted in FIG. 1;

FIG. 3 is a block diagram of the pump control of FIG. 1;

FIG. 4A is a detailed schematic diagram of a pump control circuit using the sensor unit depicted in FIGS. 1-3;

FIG. 4B is an enlarged schematic cross-sectional view of a the capacitor of the control circuit of FIG. 4A;

FIG. 5 is a flowchart of a general operation process of the sensor unit depicted in FIGS. 1-3;

FIG. 6 is a flowchart of a process of controlling a level of a liquid in a reservoir in accordance with one form of the present invention;

FIG. 7 is a flowchart of a process of controlling a level of a liquid in a reservoir in accordance with another form of the present invention;

FIG. 8 is a side view of an alternate embodiment of a sump pump disposed within a reservoir and incorporating an integrated sensor unit according to the principles of the present invention;

FIG. 9 is a perspective view of an alternate embodiment of a sump pump incorporating an integrated sensor unit in accordance with the present invention, with a portion of the outer housing shown in transparent to illustrate the internal components therein;

FIG. 10 is a top cross-sectional view of the embodiment of FIG. 9;

FIG. 11 is a top cross-sectional view of an alternate embodiment of the sump pump of FIG. 9 with the integrated sensor unit mounted in a slot of the pump housing;

FIG. 12 is an alternate embodiment of a sensor unit in accordance with the invention, showing the sensor unit connected to a discharge pipe rather than the pump housing;

FIG. 13 is a perspective view of yet another embodiment of the pump sensor and configuration for the pump and pump sensor in accordance with the invention;

FIGS. 14A, 14B, and 14C are perspective, front and rear elevational views of the sensor illustrated in FIG. 13;

FIG. 14D is a cross-sectional view of the sensor of FIGS. 14A-14C taken along line 14D-14D of FIG. 14B;

FIGS. 15A-15C are top, front and rear elevational views of a piggyback switch cord in accordance with the invention;

FIG. 15D is a wiring schematic for the piggyback switch cord of FIGS. 15A-15C;

FIG. 16 is an enlarged perspective view of a sensor circuit board in accordance with the invention illustrating a heat sink connected to the circuit board via a circuit component;

FIG. 17 is a perspective view of a dual pump system with a primary pump system incorporating a sensor unit in accordance with the invention and a battery-powered back-up pump system; the dual pump system includes a wireless or wired alert system including a receiver for informing the user of the status of the system;

FIG. 18 is a perspective view of another embodiment of the pump sensor illustrated in FIGS. 13-14D and elsewhere herein, in which one of the terminals or probes of the capacitor is located remotely from the other terminal or probe so as to reduce the likelihood of conductive material buildup between the terminals;

FIGS. 19A-B are front and rear exploded views of the pump sensor of FIG. 18 further illustrating location and potion of the probes of the capacitor;

FIG. 20 is a detailed schematic diagram of a pump control circuit using the sensor unit depicted in FIGS. 18-19B;

FIG. 21 is a block diagram of another sensor and pump control system in accordance with the invention in which a first type of sensor is used to determine when a pump device should be turned on and a second/different type of sensor is used to determine when the pump device should be turned off;

FIG. 22 is a detailed schematic diagram of a sensor and pump control in accordance with the block diagram of FIG. 21 in which a capacitive sensor is used to turn on or activate the pump and a current sensor is used to turn off or deactivate the pump;

FIG. 23 is a flowchart of a process for controlling a pump in response to current conditions and/or malfunctions detected by the current sensor;

FIGS. 24A-B are perspective and exploded views of an alternate pump and pump control or system in accordance with the invention illustrating an in-line capacitive sensor embodiment and a protective skirt member for same;

FIGS. 25A-B are exploded views of the pump control of FIGS. 24A-B illustrating the orientation and alignment of the circuit within the sensor housing;

FIGS. 25C, D and E are perspective views of the pump control of FIGS. 24A-B illustrating the circuit once inserted into the sensor housing and the protective spacing between the inner and outer walls of the sensor housing;

FIGS. 26A-B are perspective views of an alternate pump and pump control or system in accordance with the invention illustrating an embodiment that is similar to the embodiment of FIGS. 24A-B, but utilizing a piggyback power cord configuration instead of a single or integrated power cord;

FIG. 27A is a cross sectional view of an alternate self cleaning pump control or system in accordance with the invention, illustrating a pump control and pump similar to that illustrated in FIGS. 24A-26B, but having openings in the pump housing and pump control housing through which a fluid steam flows for cleaning the capacitive sensor disposed within the pump control housing;

FIG. 27B is a cross sectional view of an alternate self cleaning pump control or system in accordance with the invention, illustrating an embodiment similar to that of FIG. 27A but having a plurality of openings through which fluid streams flow for cleaning the capacitive sensor disposed within the pump control housing; and

FIG. 27C is a cross sectional view of yet another alternate self cleaning pump control or system in accordance with the invention, illustrating an embodiment similar to that of FIGS. 27A-B but having the inner pocket of the pump control housing and capacitive sensor aligned so that the fluid stream directly contacts the portions of the inner wall of the sensor housing adjacent the electrodes of the capacitive sensor rather than indirectly.

### DETAILED DESCRIPTION OF THE PREFERRED EMBODIMENT

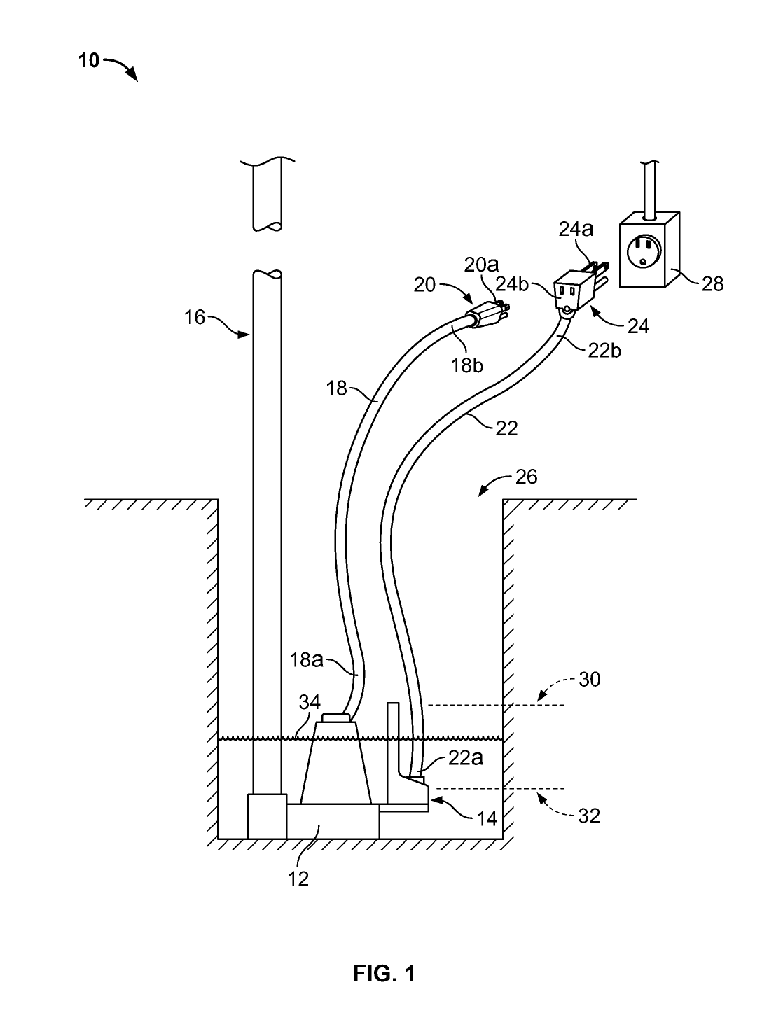

FIG. 1 depicts a sump pump system 10 disposed within a reservoir 26. The sump pump system 10 includes a pump 12, a sensor or sensor unit 14, and a discharge pipe 16. In general, the sensor unit 14 monitors the level of a liquid 34 within the reservoir 26 and serves as a switch for activating and deactivating the pump 12 based on that level. When the level of the liquid 34 reaches a predetermined upper limit, which is identified by reference numeral 30 in FIG. 1, the sensor unit 14 activates the pump 12. Upon activation, the pump 12 begins moving the liquid 34 up and out of the reservoir 26 via the discharge pipe 16. This begins to lower the level of the liquid 34 in the reservoir 26. Once the level of the liquid 34 reaches a predetermined lower limit, which is identified by reference numeral 32 in FIG. 1, the sensor unit 14 deactivates the pump 12. The details of the sump pump system 10 will now be discussed in more detail with continued reference to the figures.

FIG. 1 depicts the sensor unit 14 including a power cord, such as piggy-back cord 22, having an originating end 22a fixed to the sensor unit 14 and a terminal end 22b connected to a plug 24. The piggy-back plug 24 has a standard three-prong male connector 24a and a standard three-point female receptacle 24b. The pump 12 includes a power cord 18 having an originating end 18a fixed to the pump 12 and a terminal end 18b connected to a plug 20. The plug 20 has a standard three-prong male connector 20a. Upon installation, the male connector 24a of the piggy-back plug 24 of the sensor unit 14 is disposed within a standard 115VAC-230VAC electrical outlet, which is identified by reference numeral 28 in FIG. 1. Additionally, the male connector 20a of the plug 20 of the pump 12 is disposed within the female receptacle 24b of the piggy-back plug 24 of the sensor unit 14. Thus, the electrical outlet 28, the sensor unit 14, and the pump 12 are electrically connected in series with one another. So configured, electrical current provided by the electrical outlet 28 will only power the pump 12 when the sensor unit 14 operates as a closed switch, completing the circuit and enabling current to pass therethrough. Additionally, this configuration enables the sensor unit 14 and the pump 12 to be constructed independent of each other. An advantage of this independence is that the pump 12 and/or the sensor unit 14 may be replaced or purchased independently of the other. Meaning, the sensor unit 14 could be adapted to operate with nearly any available pump so long as the plugs are interconnectable.

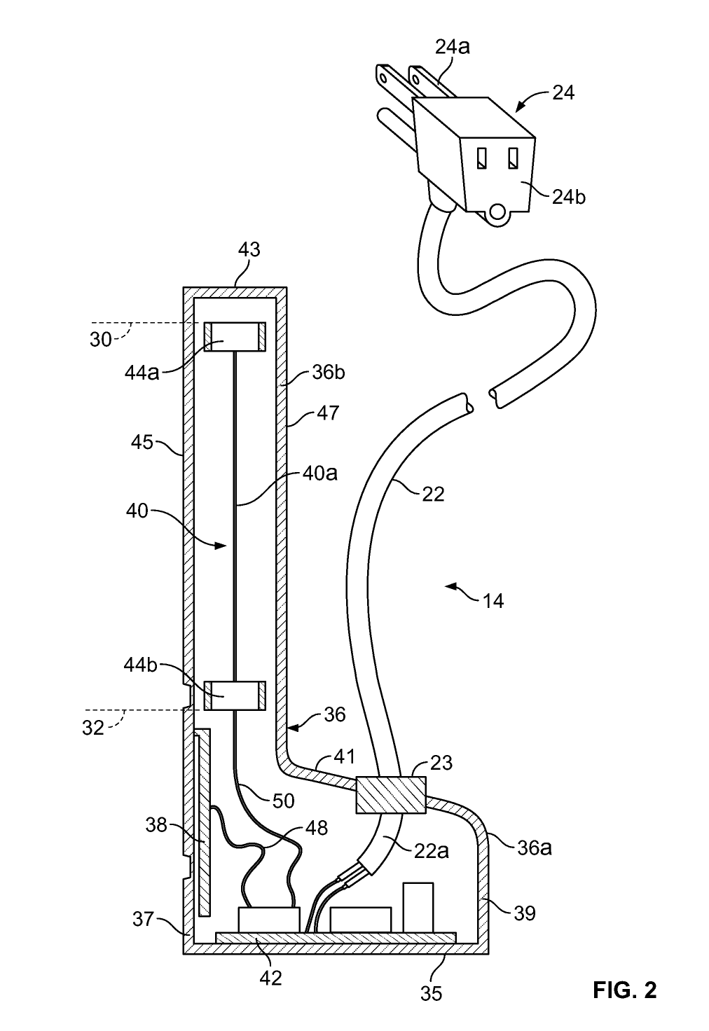

FIG. 2 depicts a more detailed view of the sensor unit 14 of the sump pump system 10 depicted in FIG. 1. As stated above, the sensor unit 14 includes a power cord 22 terminating in a piggy-back plug 24. Additionally, as depicted in FIG. 2, the sensor unit 14 includes a housing 36, a reference electrode 38, a detection electrode 40, and a circuit board 42. In the form illustrated, the housing 36 is a hollow, generally L-shaped box including a base portion 36a and an upper portion 36b extending generally perpendicularly from the base portion 36a. The base portion 36a is box-shaped and has a generally square side cross-section defined by a bottom wall 35, a first side wall 37, a second side wall 39, and a top wall 41. Additionally, the base portion 36a includes an opening in the top wall 41 receiving the originating end 22a of the power cord 22, which is electrically connected to the circuit located on circuit board 42, and preferably a strain relief 23. The upper portion 36b of the housing 36 is also box-shaped and has a generally elongated rectangular side cross-section defined by a top wall 43, a first side wall 45, and a second side wall 47.

The detection electrode 40 is disposed wholly within the upper portion 36b of the housing 36 and is situated directly above the reference electrode 38. A lower portion of the reference electrode 38 is disposed within the base portion 36a of the housing 36 and an upper portion of the reference electrode 38 is disposed within the upper portion 36b of the housing 36. The reference and detection electrodes 38, 40 each include a conductor, such as a metal plate. More specifically, in the embodiment illustrated, the detection electrode 40 includes a thin metal plate 40a having upper and lower biased portions 44a, 44b. In the form illustrated, the upper and lower biased portions 44a, 44b include metallic foil rings. The foil rings 44a, 44b enable the detection electrode 40 to provide a non-linear output across its length. For example, capacitance generated between the electrodes 38, 40 is larger when the level of the liquid 34 in the reservoir 26 is near one of the foil rings 44a, 44b than when it is near the center of the detection electrode 40. Additionally, the reference and detection electrodes 38, 40 are electrically connected to the circuit on the circuit board 40 with wires 48 and 50, respectively.

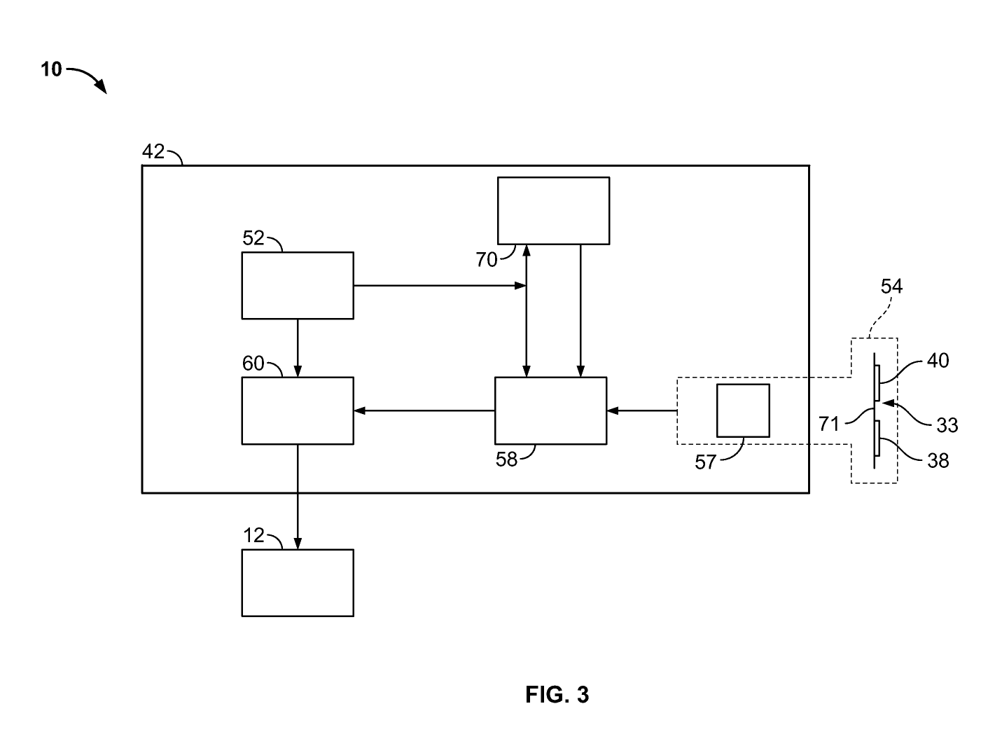

With reference to the block diagram provided in FIG. 3, the sump pump system 10 and, more particularly, the circuit board 42 includes a power supply 52, a capacitive sensor 54, a controller, such as microprocessor 58, an AC switch, such as solid state relay (SSR) 60, and signaling circuitry 70. The microprocessor 58 detects capacitance from the capacitive sensor 54 upon receipt of a signal delivered by the signaling circuitry 70, as will be described in more detail below. The microprocessor 58 then activates the pump 12 via the SSR 60 when the capacitance detected by the capacitive sensor 54 indicates that the liquid 34 in the reservoir 26 has reached the predetermined upper limit 30, as identified in FIGS. 1 and 2.

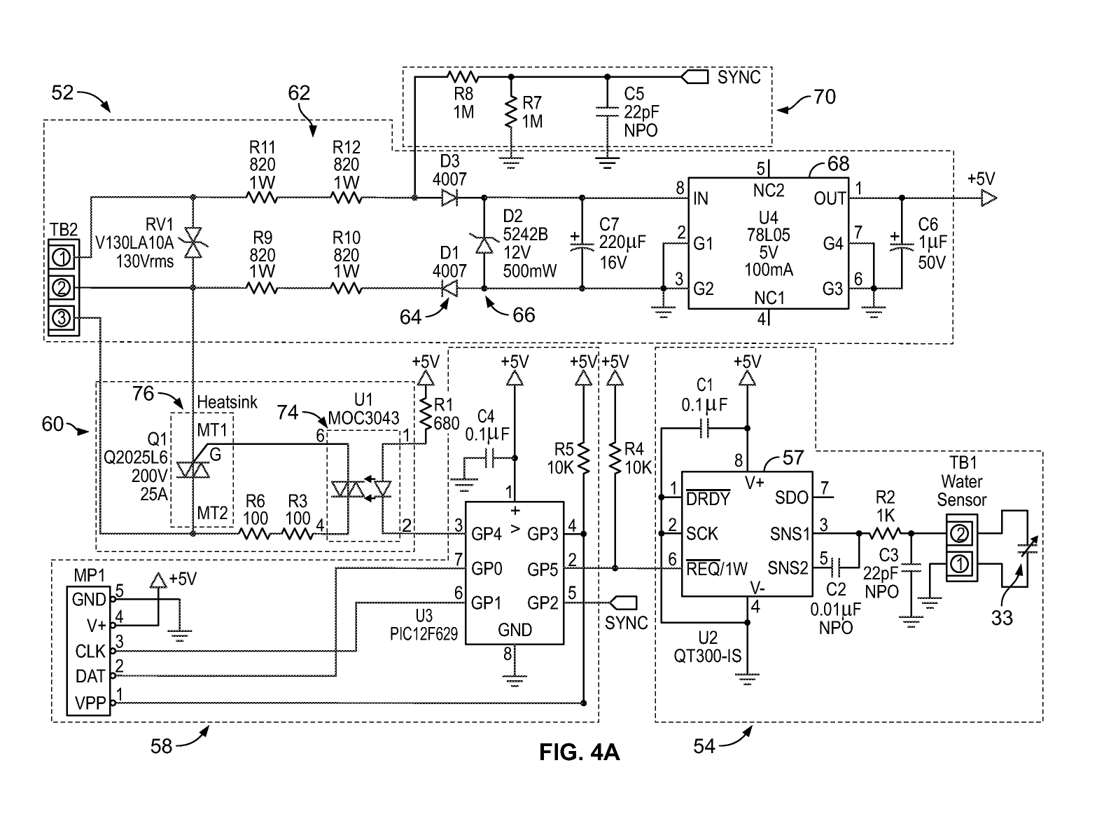

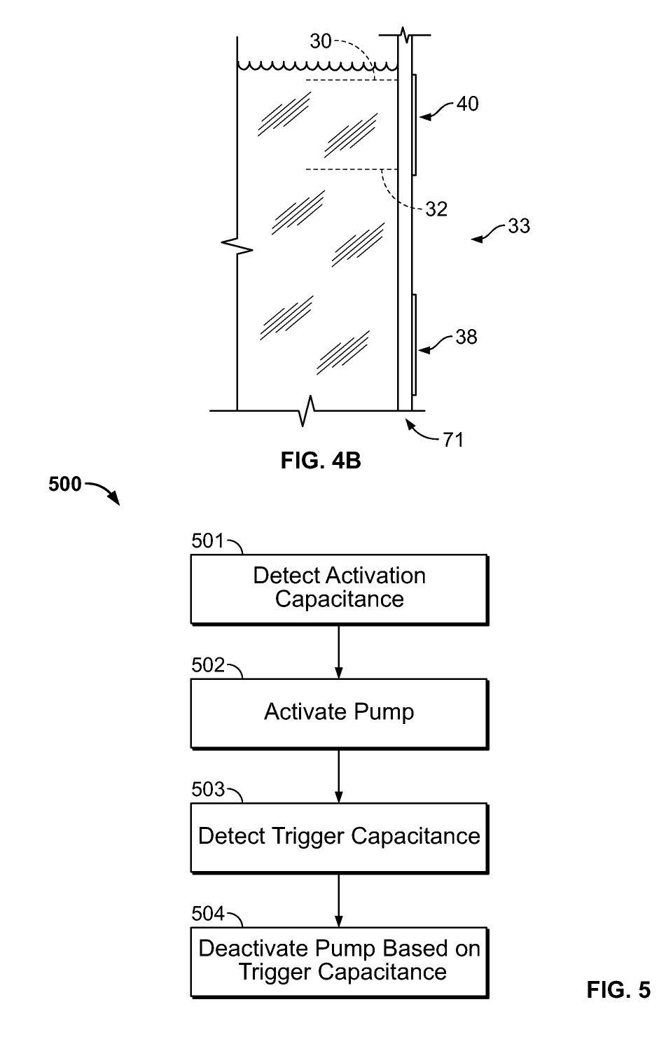

Referring now to FIGS. 3 and 4A-4B, the pump control circuit on circuit board 42 will be described in more detail. In the form illustrated, the pump control includes a power supply 52, a capacitive sensor 54, including a capacitor 33 and a capacitive sensing integrated circuit (IC) 57, a controller 58 and an AC switch 60 for actuating the pump (not shown). The power supply 52 includes an AC power source or input (e.g., 115-230VAC) (not shown), a voltage divider 62, a rectifier 64, a zener diode 66, a capacitor C7, and a voltage regulator 68. The voltage divider 62 includes a plurality of resistors R9, R10, R11 and R68 and the rectifier 64 includes two diodes D1 and D3. Together, the voltage divider 62, the rectifier 64 and the zener diode 66 step the AC voltage down to a rough or pulsating DC voltage, which in turn is filtered or smoothed out by the capacitor C7 and the voltage regulator 68 to generate a 5VDC output. This 5VDC output is supplied to various components of the circuit including, among other items, the capacitive sensor 54 and the microprocessor 58.

The signaling circuitry 70 comprises a line brought off of the AC input to the microprocessor (pin 5) through a current limiting resistor R8 to tell the processor when the input voltage signal is low enough to back bias the rectifier diodes. This tells the microprocessor to take a measurement reading from the capacitive sensor IC when there is a high impedance between the power line and reading circuitry, which minimizes the effects of stray capacitance tied to the two sensor plates 38 and 40 isolated by the dielectric layer 71. Thus, when the signaling circuitry 70 monitors the voltage from the power supply 52 and informs the microprocessor 58 when a zero-crossing of the voltage input signal occurs, the input voltage signal is low enough to back bias the diodes D1 and D3 of the rectifier 64 so that the microprocessor 58 can take an accurate reading from the capacitor 33.

The capacitor 33 includes the reference electrode 38, the detection electrode 40, a dielectric wall 71, and a capacitive sensing integrated circuit (IC), such as capacitance-to-digital converter 57, which is connected to the capacitor 33 so that the controller 58 can read and process the capacitance of capacitor 33 at the zero-crossings of the AC supply. It should be understood, however, that in alternate embodiments, a controller may be selected which can read and process data directly from the capacitor 33, if desired.

With reference to FIG. 4A, the dielectric wall 70 includes the first side wall 45 of the housing 36 of the sensor unit 14, as described above with reference to FIG. 2. The dielectric wall 70 serves to isolate the reference and detection electrodes 38, 40 from the liquid 34 in the reservoir 26, thereby creating capacitor 33. In a preferred form, the electrodes 38, 40 are positioned flush against the dielectric as illustrated in FIG. 4B so as to avoid air gaps between the dielectric and the electrodes 38, 40. In this form, the electrodes may be attached to the dielectric with epoxy so no air gaps will exist between the capacitor electrodes and the dielectric, which would otherwise negatively affect the performance of the capacitive sensor. In another form, the electrodes 38, 40 are encased in the insulative material of the dielectric, which also would eliminate air gaps between the electrodes and the dielectric. The reference electrode 38 is electrically connected to circuit ground and the detection electrode 40 is electrically connected to the capacitive sensing IC 57, as depicted schematically in FIG. 4A. The level of the liquid 34 in the reservoir 26 alters the performance of the side wall 45 and ultimately the value of capacitance generated by the capacitor 33. Thus, in this way, the dielectric is made up in part by the side wall 45 and in part by the liquid 34 so that the capacitance of capacitor 33 varies in relation to the liquid level of liquid 34.

In the form illustrated in FIG. 2, the side wall 45 is made of a polymer, such as plastic, and the housing 36 is filled with a protective material, such as a potting compound, to protect the capacitor 33 and other electronic circuit components from exposure to the liquid within which the capacitor 33 is immersed. The housing is first partially filled with the potting compound before the circuit board is inserted. Then, after the circuit board is inserted, the housing is filled with additional potting compound to fully protect the circuit components. The potting compound used to fill the housing after the circuit board is inserted may be the same potting compound as the first, or it may be of a different composition. For example, a second, different potting compound may be used for certain applications, such as sewage applications, where external conditions dictate the use of different materials. A small piece of foam may be used to hold the circuit board against the inside wall of the housing while the potting compound cures. This method has also been found effective to keep air from being trapped between the electrodes 38, 40 and the dielectric. However, as mentioned above, in a preferred form the electrodes 38, 40 are either epoxied to the dielectric wall 45 or encased in the dielectric wall to eliminate air gaps. In this form, the capacitance generated by the reference and detection electrodes 38, 40 varies from approximately 1 picofarad (pF) with the level of the liquid 34 in the reservoir 26 being located at the predetermined lower limit 32 of the detection electrode 40 to approximately 11 pF at the predetermined upper limit 30 of the detection electrode 40. As will be discussed more thoroughly below, the microprocessor 58 reads the capacitance generated by the reference and detection electrodes 38, 40 from the capacitive sensing IC 57. When the capacitance indicates that the level of the liquid 34 has reached the predetermined upper limit 30, the microprocessor 58 actuates the AC switch or SSR 60, which activates the pump 12.

The SSR 60 includes an opto-triac 74 and an AC solid state switch, such as a triac 76, or an alternistor. The switch 76 is electrically connected between the AC power supply 52 and the pump 12, and the opto-triac 74 is electrically connected between switch 76 and the microprocessor 58. The opto-triac 74 provides a zero voltage switch for triggering the switch 76 and, in the form illustrated, the switch 76 performs substantially the same function as two thyristors such as silicon controlled rectifiers (SCRs) wired in inverse parallel (or back-to-back). Thus, the opto-triac 74 drives the switch 76 and isolates or protects the microprocessor 58 and the other digital circuitry from the non-rectified AC signal that passes through the switch 76 when the pump 12 is activated. Additionally, the switch 76 allows both the positive and negative portions of the AC signal to be passed through to operate the pump 12.

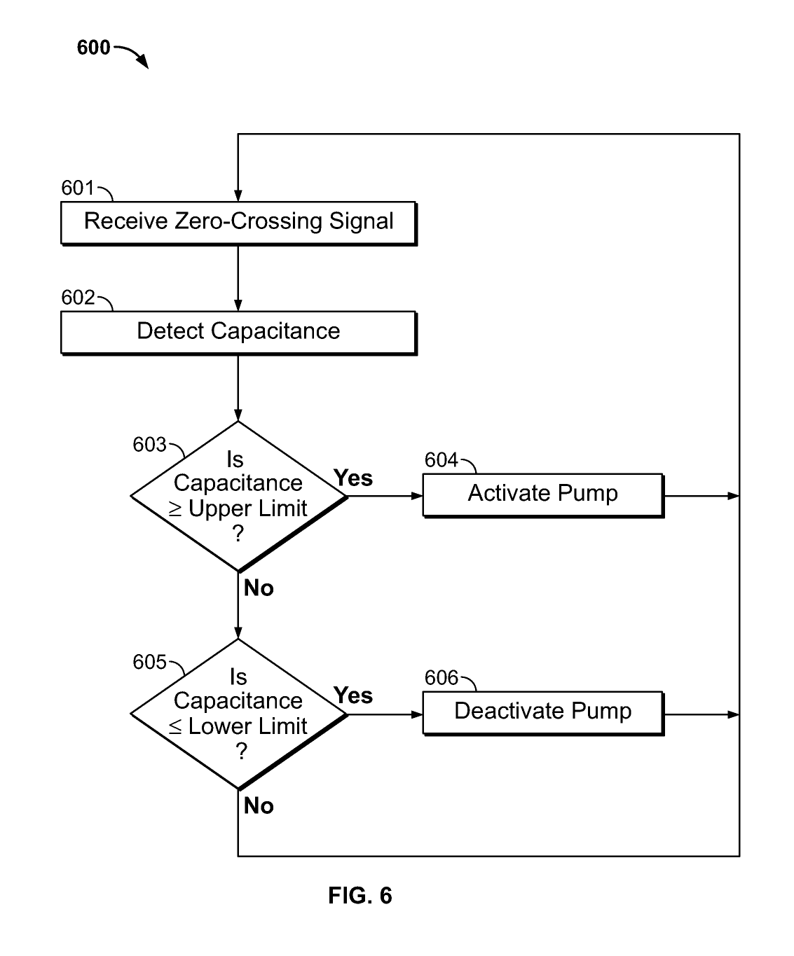

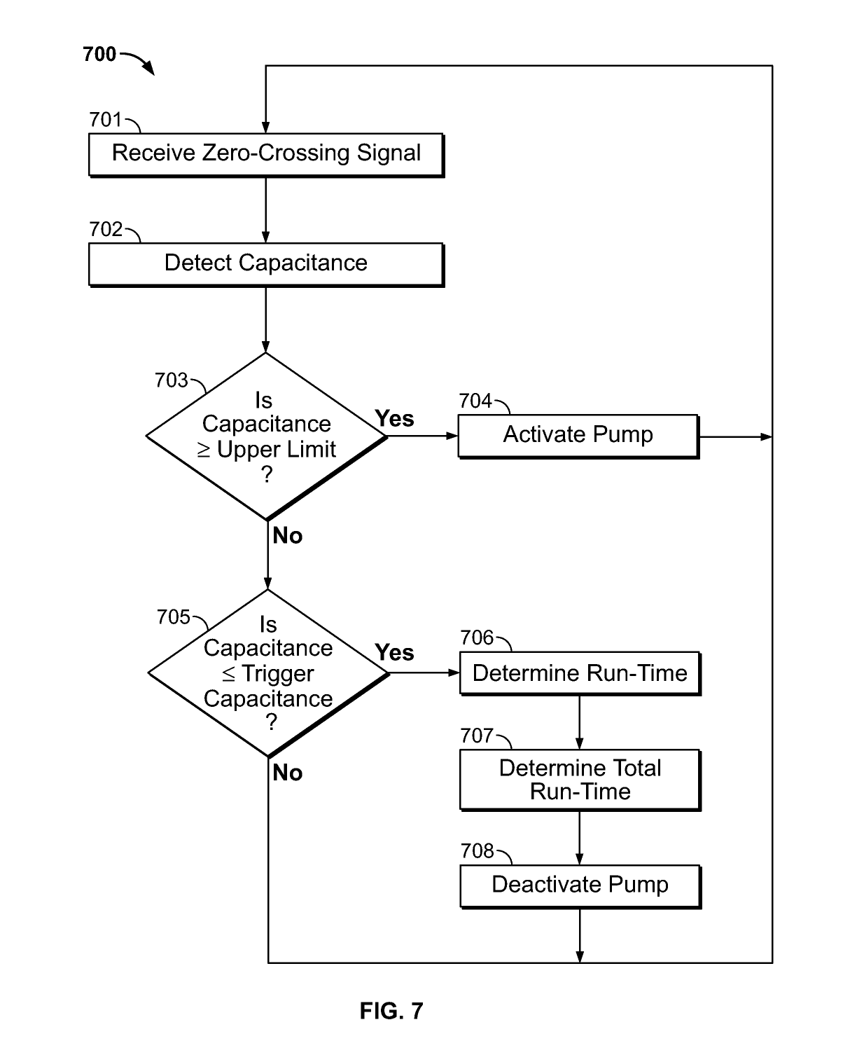

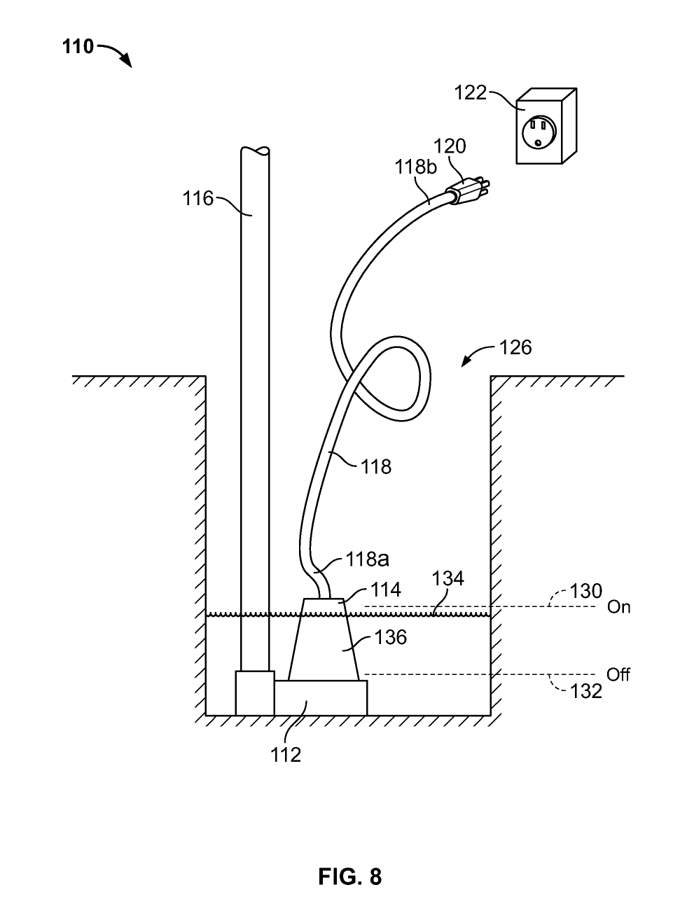

FIG. 5 depicts a flowchart of a general operational process performed by the microprocessor 58 of the sump pump system 10. First, when the level of the liquid 34 in the reservoir 26 reaches the predetermined upper limit 30, the microprocessor 58 detects the existence of an activation capacitance (e.g., equal to or above a predetermined capacitance) from the capacitor 33 of the sensor unit 14 at block 501. The microprocessor 58 then activates the pump 12 at block 502 to begin moving the liquid 34 out of the reservoir 26. Meanwhile, the microprocessor 58 continues detecting the capacitance generated by capacitor 33. Once the level of the liquid in the reservoir 26 falls to the lower limit 32 shown in FIGS. 1 and 2, the microprocessor 58 will detect the existence of a sample or trigger capacitance (which may be equal to or below a predetermined capacitance or alternatively a random capacitance) from the capacitor 33 at block 503, resulting in the microprocessor 58 deactivating the pump 12 at block 504. For example, in one form, the trigger capacitance is a predetermined value of capacitance and the microprocessor 58 simply deactivates the pump 12 when the trigger capacitance was detected. In another form, however, the trigger capacitance is either a predetermined capacitance value or a random capacitance value that simply allows the microprocessor 58 to calculate the flow rate of the liquid 34 evacuating the reservoir 26 so that the microprocessor 58 can determine how long the pump 12 should remain operating. This process will be discussed in greater detail below with reference to the various embodiments described with reference to FIGS. 6 and 7.

FIG. 6 depicts a detailed flowchart of a process 600 performed by the microprocessor 58 for activating and deactivating the pump 12 according to the present invention. The process 600 controls the level of the liquid 34 in the reservoir 26 by utilizing a sump pump system 10 such as that described above. First, the microprocessor 58 receives a zero-crossing signal from the signaling circuitry 70 at block 601. Substantially immediately thereafter, the microprocessor 58 detects a capacitance generated by the capacitor 33 at block 602. Specifically, in the form of the sump pump system 10 discussed above, the capacitance is generated between the reference and detection electrodes 38, 40 of the capacitor 33 and detected and translated to digital data by the capacitance-to-DC converter 57 so that the microprocessor 58 can process the digital data and determine whether to activate or deactivate the pump 12.

After the microprocessor 58 detects the capacitance, it determines whether the detected capacitance is equal to a predetermined upper limit capacitance at block 603. The predetermined upper limit capacitance corresponds to a capacitance generated by the electrodes 38, 40 when the level of the liquid 34 in the reservoir 26 is at the predetermined upper limit 30 shown in FIGS. 1 and 2. In the event the detected capacitance is equal to the upper limit capacitance, the microprocessor 58 activates the pump 12 at block 604 to move the liquid 34 out of the reservoir 26 via the discharge pipe 16. Specifically, in the form of the sump pump system 10 discussed above, the microprocessor 58 triggers or turns on the opto-triac 74 and the opto-triac 74 triggers or turns on the switch 76. This closes the circuit between the AC power supply and the pump 12 allowing the alternating current to travel directly to the pump 12 to operate the pump 12. Once the microprocessor 58 activates the pump 12, it waits to receive another zero-crossing signal from the signaling circuitry 70 at block 601 and repeats the process 600 accordingly.

Alternatively, if the microprocessor 58 determines at block 603 that the capacitance detected at block 602 is not equal to the predetermined upper limit capacitance, the microprocessor 58 determines whether the detected capacitance is less than or equal to a trigger capacitance at block 605. In this form of the process 600, the trigger capacitance is equal to a predetermined lower limit capacitance, which corresponds to a capacitance generated by the electrodes 38, 40 when the level of the liquid in the reservoir 26 is at the predetermined lower limit 32 shown in FIGS. 1 and 2. If the detected capacitance is greater than the lower limit capacitance, the microprocessor 58 returns to receiving zero-crossing signals from the signaling circuitry 70 at block 601. Alternatively, however, if the detected capacitance is less than or equal to the lower limit capacitance, the microprocessor 58 deactivates the pump 12 at block 606 and then returns to receiving zero-crossing signals from the signaling circuitry 70 at block 601. The process 600 thereafter repeats itself.

FIG. 7 depicts a detailed flowchart of an alternative process 700 performed by the microprocessor 58 for activating and deactivating the pump 12. The process 700 controls the level of the liquid 34 in the reservoir 26 utilizing a sump pump system 10 such as that described above. First, the microprocessor 58 receives a zero-crossing signal from the signaling circuitry 70 at block 701. Substantially immediately thereafter, the microprocessor 58 detects a capacitance generated by the capacitor 54 at block 702. Specifically, in the form of the sump pump system 10 discussed above, the capacitance is generated between the reference and detection electrodes 38, 40 and stored by the capacitance sensing IC 57. Therefore, the microprocessor 58 detects or reads the capacitance from the IC 57.

After the microprocessor 58 detects the capacitance, it determines whether the detected capacitance is equal to a predetermined upper limit capacitance at block 703. The predetermined upper limit capacitance corresponds to a capacitance generated by the electrodes 38, 40 when the level of the liquid 34 in the reservoir 26 is at the predetermined upper limit 30 shown in FIGS. 1 and 2. In the event the detected capacitance is equal to the upper limit capacitance, the microprocessor 58 activates the pump 12 at block 704 to move the liquid 34 out of the reservoir 26 via the discharge pipe 16. Specifically, in the form of the sump pump system 10 discussed above, the microprocessor 58 triggers or turns on the opto-triac 74 and the opto-triac 74 triggers or turns on the switch 76. This completes the circuit between the AC power supply and the pump 12 and allows the alternating current provided by the power supply to operate the pump 12. Once the microprocessor 58 activates the pump 12, it waits to receive another zero-crossing signal from the signaling circuitry 70 at block 701 and proceeds accordingly.

Alternatively, if the microprocessor 58 determines at block 703 that the capacitance detected at block 702 is not equal to the predetermined upper limit capacitance, the microprocessor 58 determines whether the detected capacitance is less than or equal to a predetermined trigger capacitance at block 705. The predetermined trigger capacitance is equal to a capacitance generated by the reference and detection electrodes 38, 40 when a surface of the liquid in the reservoir 26 is at a predetermined location below the upper limit 30 illustrated in FIGS. 1 and 2, but above the lower limit 32 illustrated in FIGS. 1 and 2. In one embodiment of the present invention, the trigger capacitance is measured when the surface of the liquid 34 in the reservoir 26 is approximately 1 inch below the upper limit 30. However, such trigger capacitance may be measured at virtually any location along the detection electrode 40 that is below the upper limit 30 and above the lower limit 32.

Nevertheless, if the microprocessor 58 determines at block 705 that the detected capacitance is not less than or equal to the trigger capacitance, the microprocessor returns to receiving zero-crossing signals from the signaling circuitry 70 at block 701. Alternatively, however, if the microprocessor 58 determines at block 705 that the detected capacitance is less than or equal to the trigger capacitance, it calculates a run-time at block 706.

The run-time is the amount of time that it took to pump down the liquid 34 in the reservoir 26 from the upper limit 30 to the predetermined location between the upper and lower limits 30, 32. The microprocessor 58 determines this run-time by monitoring the time that passed between when the microprocessor 58 determined the capacitance to be equal to the predetermined upper limit capacitance and when the microprocessor determined the capacitance to be equal to the trigger capacitance. In one form of the process 700, this determination may be made by using an internal clock in the microprocessor 58 to determine how much time has lapsed between the start of the pump and/or detection of the predetermined upper limit capacitance and detection of the trigger capacitance. However, it should be appreciated that the microprocessor 58 may determine this run-time in any effective manner which allows the microprocessor 58 to calculate the flow rate of the liquid 34 being moved out of the reservoir 26.

After determining the run-time at block 706, the microprocessor 58 calculates a total run-time at block 707. The total run-time is a factor of the run-time and corresponds to how long the pump 12 should remain activated to lower the level of the liquid 34 in the reservoir 26 to the predetermined lower limit 32 or some other desired level. In one form, the total run-time determined at block 707 is five times the run-time determined at block 706. Therefore, after the total run-time passes, the microprocessor 58 deactivates the pump 12 at block 708 and returns to receiving subsequent zero-crossing signals from the signaling circuitry 70 at block 701 and the process repeats itself accordingly.

While the above-described process 700 has been described as including a determination of a run-time and a total run-time, an alternate form of the process may include a determination of a flow rate at which the level of the liquid 34 drops between the microprocessor 58 detecting the upper limit capacitance and the trigger capacitance. In such a case, the microprocessor 58 would deactivate the pump 12 only after the pump 12 has removed a predetermined volume of liquid 34 out of the reservoir 26.

Additionally, it should be appreciated that while the above-described processes 600 and 700 have been described as including a series of actions described according to a sequence of blocks or steps, the present invention is not intended to be limited to any specific order or occurrence of those actions. Specifically, the present invention is intended to include variations in the sequences at which the above-described actions are performed, as well as additional or supplemental actions that have not been explicitly described, but could otherwise be successfully implemented.

Furthermore, in a preferred embodiment of the processes 600, 700 described above, the microprocessor 58 is programmed to activate the pump 12 for a minimum of four seconds and a maximum of sixteen seconds. Additionally, the microprocessor 58 is programmed to insure deactivation of the pump 12 for a minimum of one second between activation and deactivation. It should be appreciated, however, that such specific activation and deactivation periods are merely exemplary and that the microprocessor 58 may be programmed to accommodate various different sizes, models and configurations of pumps 12 and, therefore, these timings may also be changed to satisfy the desired conditions for any given application.

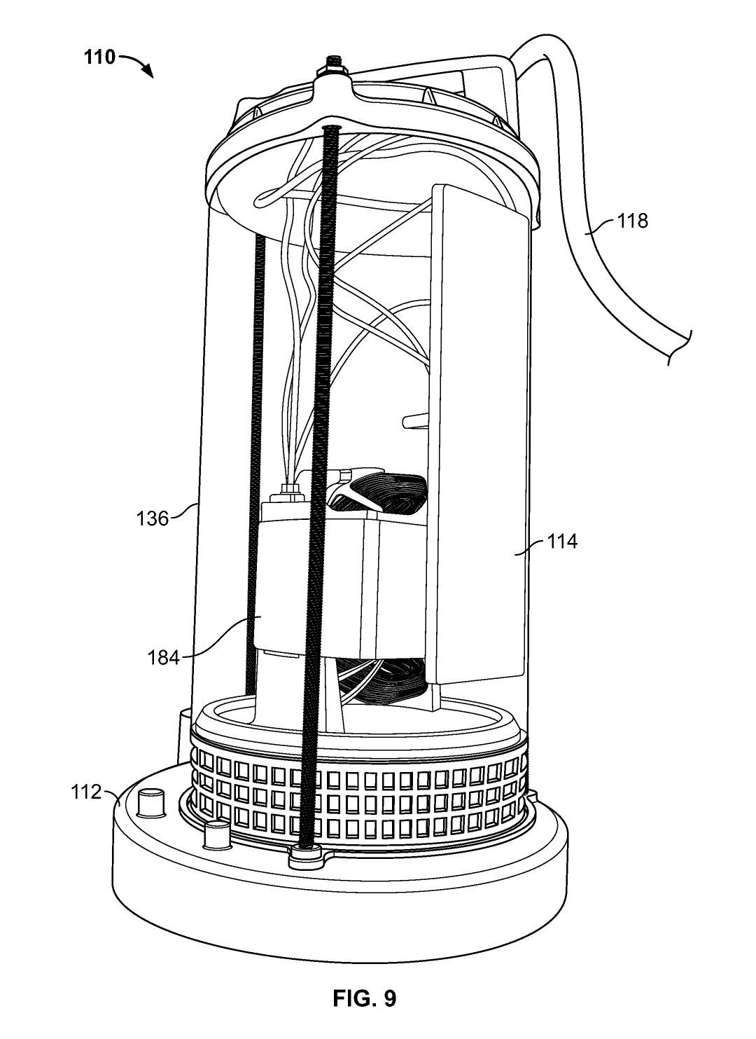

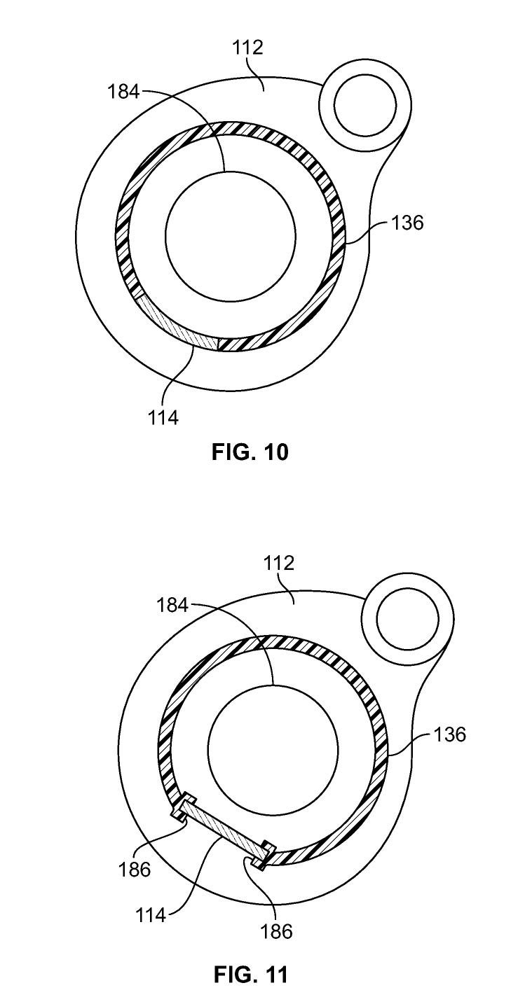

Referring now to FIGS. 8 and 9, alternative embodiments of systems are shown using a sensor in accordance with the invention. For convenience, features of the alternate embodiments illustrated in FIGS. 8-9 that correspond to features already discussed with respect to the embodiment of FIGS. 1-7 are identified using the same reference numerals in combination with the prefix “1” merely to distinguish one embodiment from the other, but otherwise such features are similar. In this form, sump pump system 110 includes a pump 112 powered by a motor 184, a sensor unit 114, and a liquid discharge pipe 116. Unlike the sump pump system 10 described above, the pump 112 and the sensor unit 114 are an integral unit sharing a common power cord 118. The power cord 118 includes an originating end 118a fixed to the sensor unit 114 and a terminal end 118b connected to a plug 120. The plug 120 is adapted to be electrically connected to a standard electrical outlet 122, similar to that described above with reference to the first embodiment of the sump pump system 10. Therefore, while the electrical connection between the sensor unit 14 and the pump 12 described in accordance with the first embodiment of the sump pump system 10 was achieved externally via the different cords, the same electrical connection is made in the sump pump system 110 of this alternative embodiment internally. Specifically, the sensor unit 114 and the pump 112 are hard-wired together and constructed as a single operational unit. Otherwise all features, characteristics and functions are generally the same as described above regarding the first embodiment and will not be described in detail again.

In the form illustrated, the capacitor is disposed in the housing 136 of the pump 112 and uses an outer wall of the housing 136 as part of the dielectric and the liquid level of liquid 134 with respect to the housing 136 to affect the dielectric performance and capacitance of the variable capacitor of capacitive sensor 114. Thus, when the liquid level of liquid 134 raises or lowers with respect to housing 136, a corresponding change in capacitance will be detected by sensor 114. When the detected capacitance is equal to or greater than the capacitance associated with the predetermined upper limit 130, the pump will be activated to evacuate liquid out of the reservoir 126 until the liquid 134 has dropped below a desired lower limit 132.

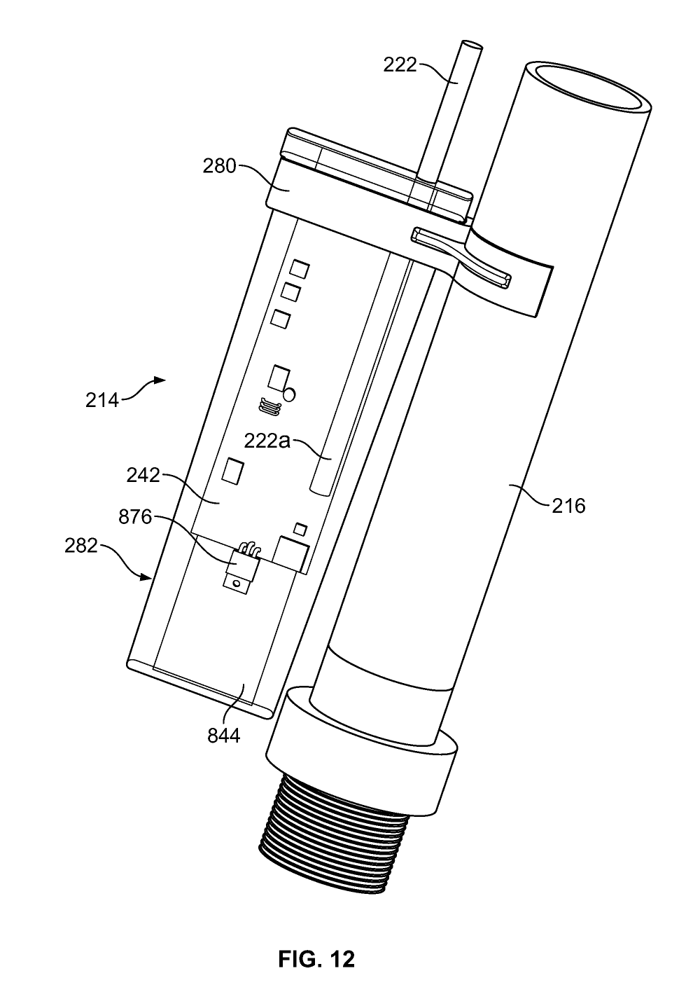

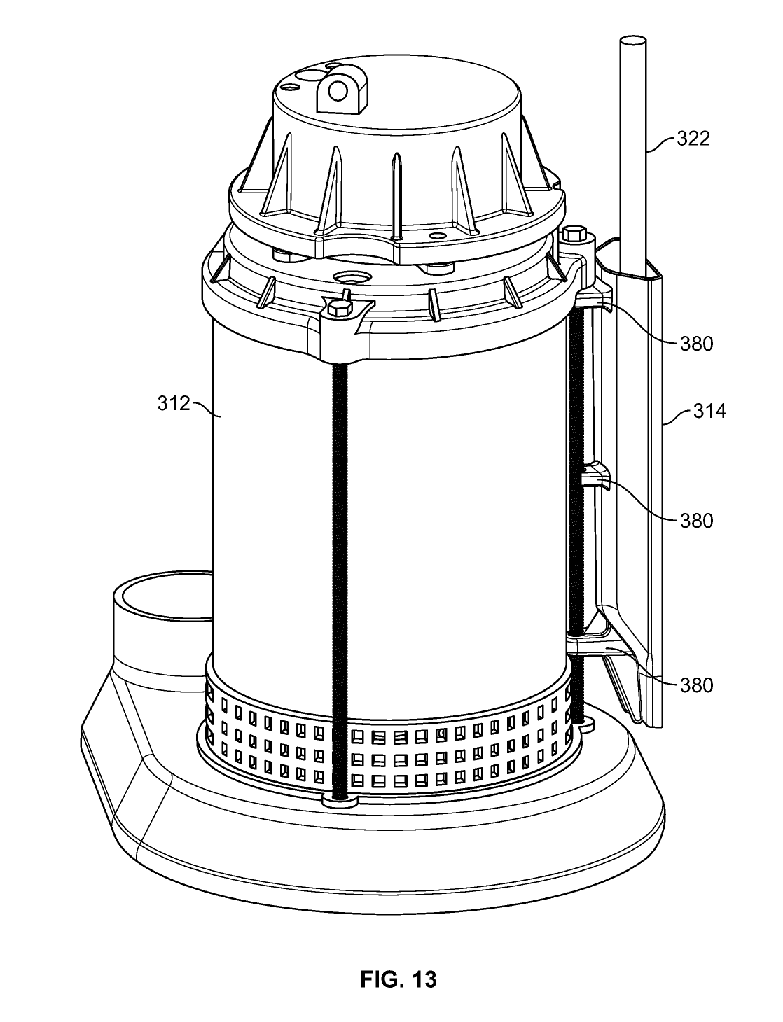

In the forms illustrated in FIGS. 9-11, the sensor 114 is disposed in the outer wall of the housing 136 and at least a portion of the outer housing is shown in transparent so that the internal components and sensor 114 can be seen therein. In one form shown in FIGS. 9 and 10, the sensor 114 may be molded directly into the housing wall 136. Alternatively, the sensor 114 may be coupled to the housing by fitting into a slot 186 formed in the housing wall 136. The sensor 114 may have an arcuate configuration to match the curvature of the housing wall 136, as shown in FIG. 10, or it may have a flat configuration, as shown in FIG. 11. The configurations described above are merely examples in accordance with the present invention, and other configurations are contemplated, as would be apparent to those skilled in the art.

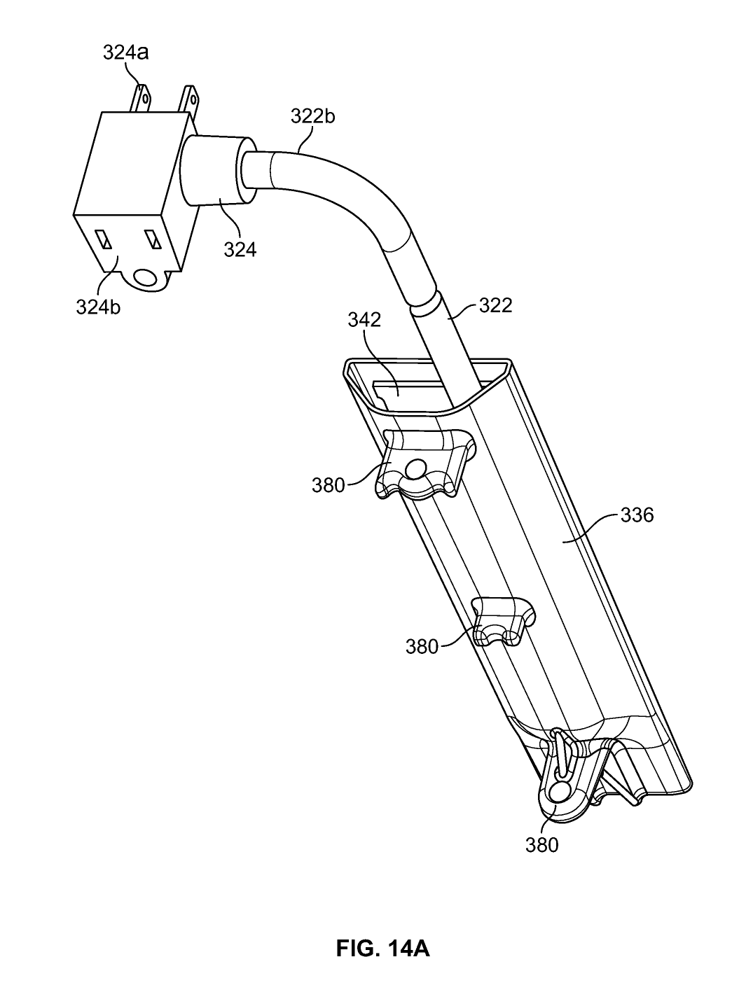

Another embodiment of the pump sensor is illustrated in FIG. 12 and, for convenience, features of this embodiment that correspond to features already discussed with respect to the embodiment of FIGS. 1-11 are identified using the same reference numeral in combination with the prefix “2” merely to distinguish one embodiment from the other, but otherwise such features are similar. In the form illustrated, the capacitive sensor 214 is shown connected to the discharge pipe 216 via a mounting bracket 280. The bracket 280 allows the sensor 214 to be positioned at any desired location on the discharge pipe 216, which allows the operator to determine how much liquid he or she wishes to maintain in the reservoir (not shown). For example, if an operator wishes to maintain a larger amount of liquid in the reservoir, the operator may slide the sensor 214 up the discharge pipe 216 and away from the pump (not shown) so that the predetermined upper limit for the liquid level is reached more slowly. Conversely, if the operator wishes to maintain less liquid in the reservoir, the operator may slide the sensor 214 down the discharge pipe 216 closer to the pump so that the predetermined upper limit for the liquid level is reached faster. In this way, the bracket 280 further allows the operator or installer to account for reservoirs or pits of different sizes and configurations.

An alternate housing 282 is also used for the sensor 214. In the form illustrated, the housing 282 forms more of an elongated sleeve with a longitudinal axis running generally parallel to the pipe 216. In this drawing the housing 282 is shown as being partially transparent so that the circuit board 242 and power cord end 222a of piggyback cord 222 are visible through the housing 282. In a preferred form, however, the housing 282 will be opaque and filled with a suitable potting material for protecting the circuit and circuit components on circuit board 242 from exposure to the liquid in which the sensor 214 is immersed. With this configuration, the length of the housing may be selected based on the pump application. For example, if a longer level sensor plate is desired so that the capacitor may track a larger range of liquid levels, the housing 282 can be elongated to accommodate the larger level sensor plate.

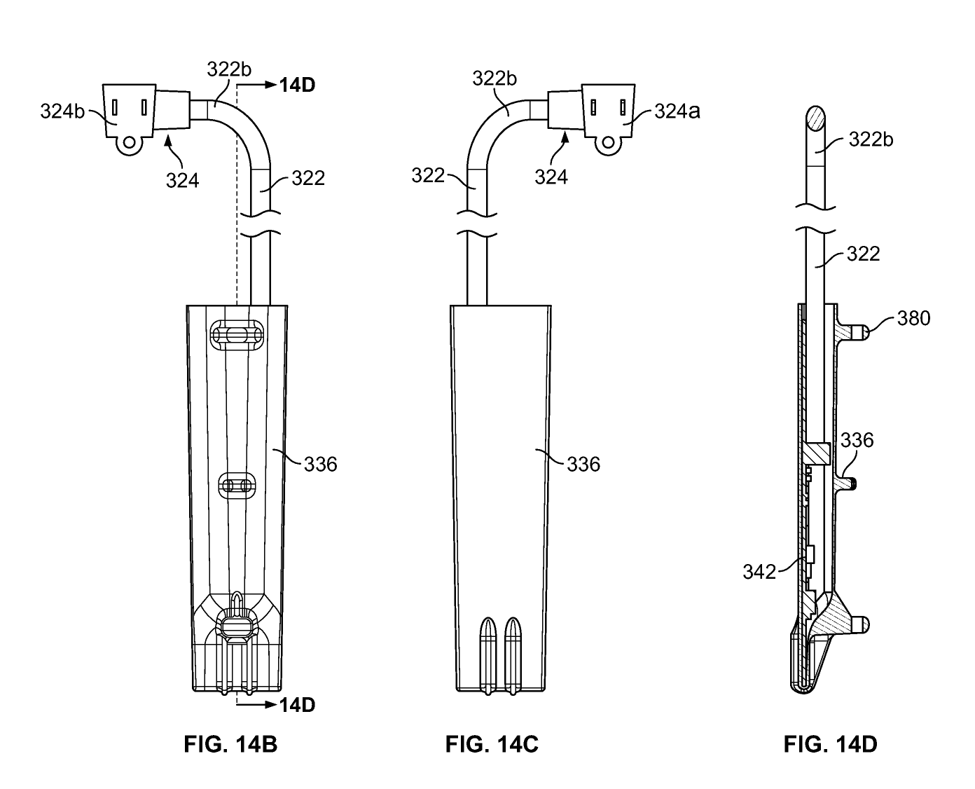

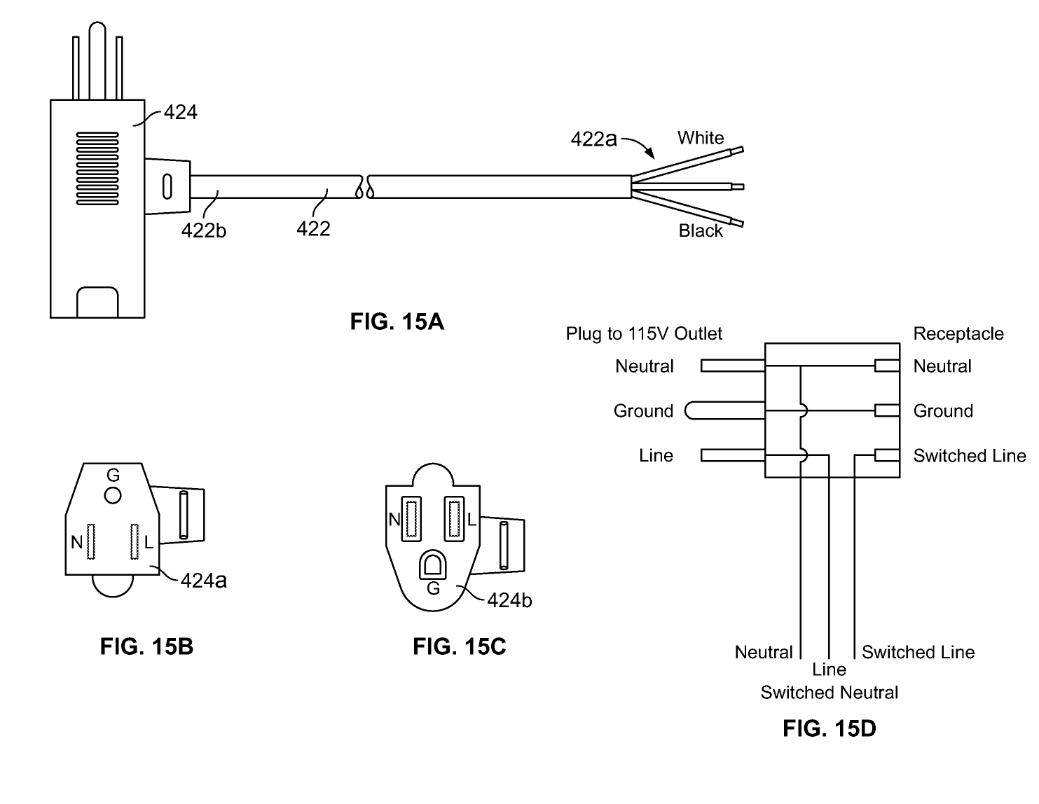

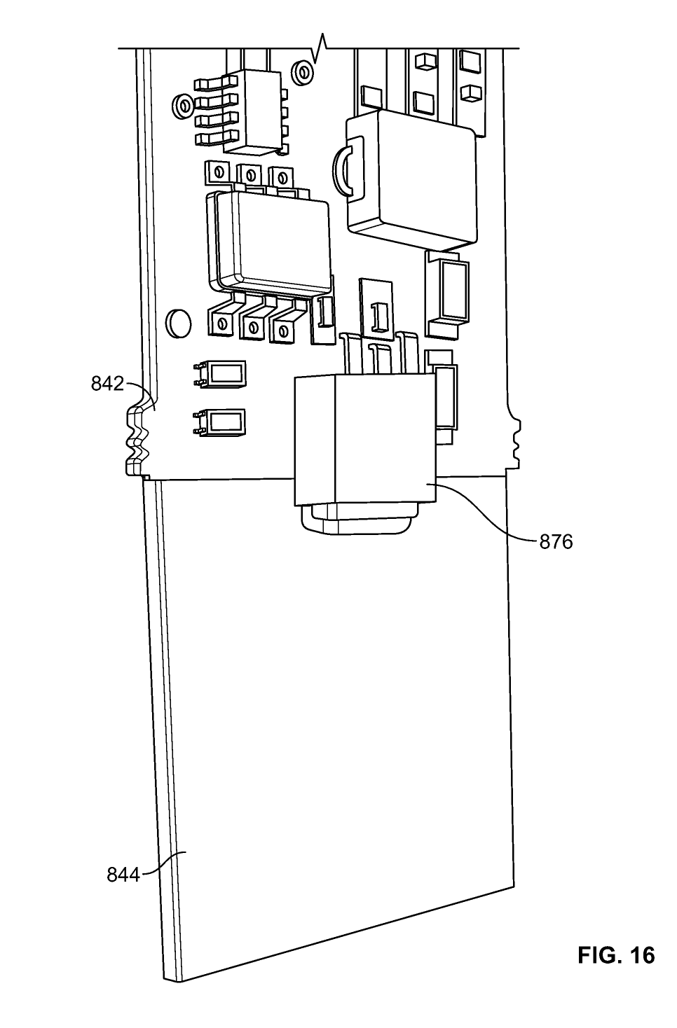

Yet another embodiment of the sensor and configuration for the pump and sensor are illustrated in FIGS. 13 and 14A-14D. As has been done before, features of this embodiment that correspond to features already discussed with respect to the embodiment of FIGS. 1-11 are identified using the same reference numeral in combination with the prefix “3” merely to distinguish one embodiment from the other, but otherwise such features are similar. In the form illustrated, the sensor 314 is connected to the pump 312 via a plurality of mounting brackets 380. Although a hollow housing 336 is illustrated so that the circuit board 342 may be seen, the housing 336 will preferably be filled with a potting material to protect the circuit and components on the circuit board 342 from the liquid in which the sensor 314 will be disposed.

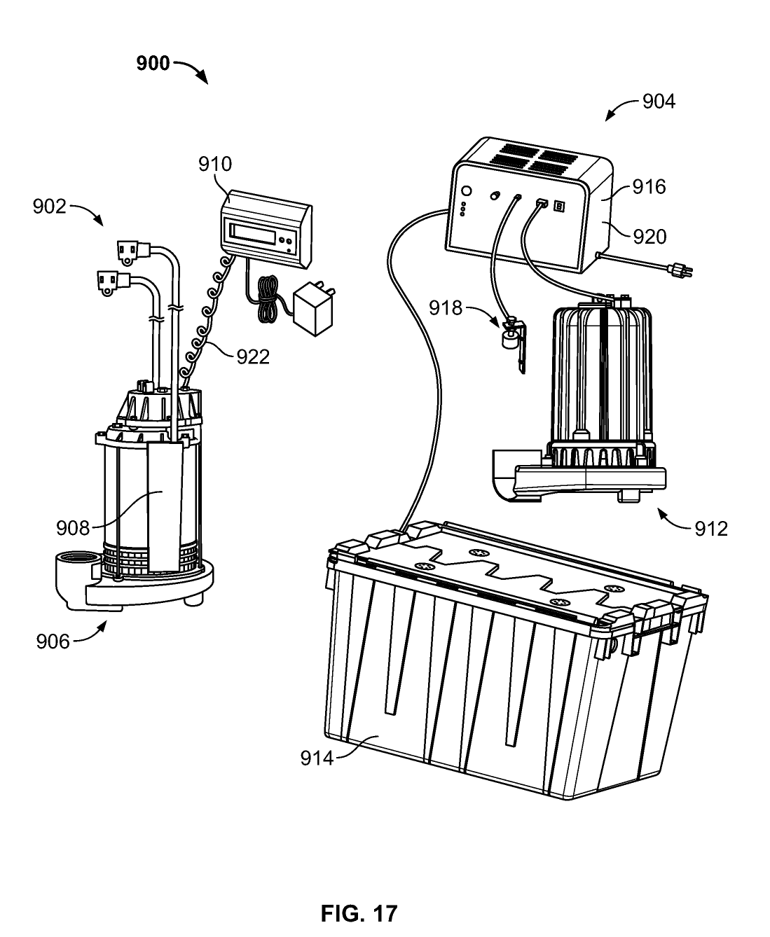

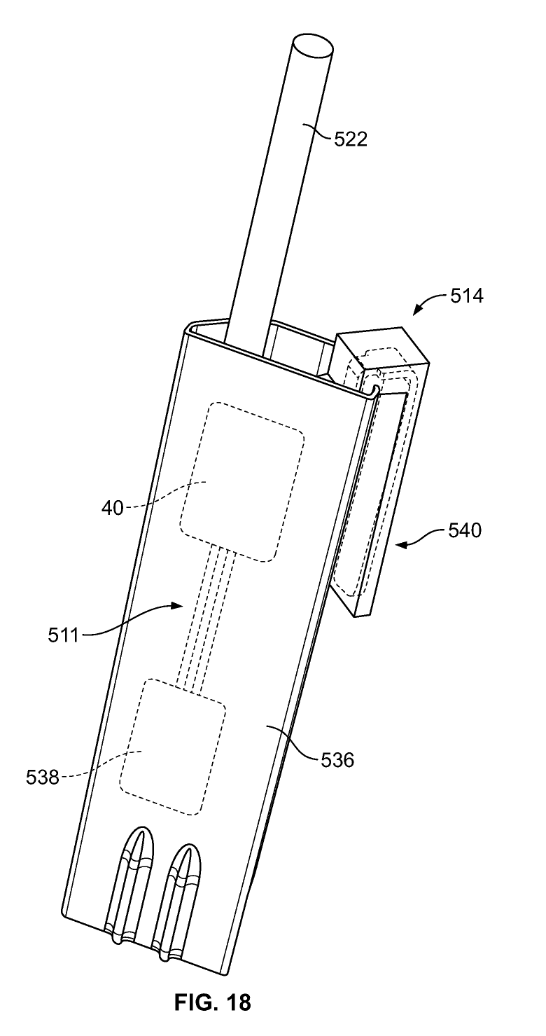

FIGS. 15A-15D illustrate one form of a piggyback power cord 422 for use with the embodiments illustrated herein and provide a wiring schematic for same. It should be understood, however, that alternate forms of piggyback cords may be provided so long as these cords allow the pump control disclosed herein to complete the circuit between the pump and the power source when a desired liquid level has been reached to activate the pump and break the circuit between the pump and power supply to deactivate the pump.

Although the embodiments illustrated thus far have had the level sensor plate (e.g., 30, etc.) of capacitor 33 located on top and the reference plate (e.g., 32) of capacitor 33 located below the level sensor plate, it should be understood that in alternate embodiments, the level sensor plate may be located below the reference plate. Such a configuration may be particularly advantageous in applications wherein a very minimal amount of liquid is to be monitored and/or maintained. For example, by placing the level sensor plate in the bottom of the capacitive sensor, liquids may be monitored and maintained much closer to the bottom of the pump and/or the bottom surface of the reservoir. In some applications, however, such a configuration will not be desired due to high contamination levels in the liquid causing deposits and/or foaming on the surface of the housing of the sensor opposite the level sensor plate or due to residual surface moisture lingering or being present on the surface of the housing of the sensor opposite the level sensor plate.

These and other concerns may also provide grounds for taking the sampling capacitance at a position slightly below the upper limit and/or well above the bottom of the level sensor plate and calculating a run-time for the pump to operate rather than trying to detect exactly when the liquid has dropped to a desired level on the level sensor plate. For example, if the lower portion of the level sensor plate contains residual surface moisture, this moisture may affect the readings of the capacitor (e.g., 33) and cause the pump control to continue to operate as if the liquid level has not dropped to the desired level on the level sensor plate because the residual water is affecting the capacitance reading of the capacitor.

In light of the foregoing, it should be understood that additional and/or supplemental features and processes are intended to be within the scope of the present invention. For example, the sensor unit 14 may include noise filtering components in order to ensure that the sensor unit 14 operates properly and efficiently. In another alternative form, a temperature sensor may be connected to the SSR 60 in order to limit the run-time of the pump 12. The temperature sensor may monitor the temperature of the opto-triac 74 and/or the switch 76 and, if the device gets too hot, direct the microprocessor 58 to deactivate the pump.

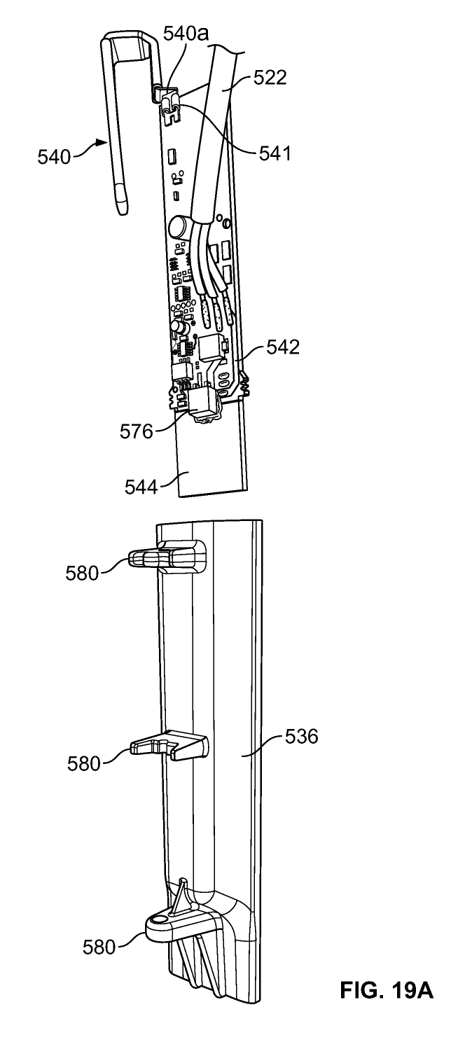

In a preferred form shown in FIGS. 12 and 16, a portion of the switch 76 discussed above, which is illustrated as triac 876 in these figures, is mounted to the circuit board 842 and another portion is mounted to a heat sink, such as a copper plate 844, to prevent the switch 876 from overheating. The heat sink is attached to the triac 876 using a surface mount reflow process, which can be undertaken at the same time that the other circuit components are being soldered to the circuit board. This process eliminates a separate process step as well as reduces labor time. In effect, the thermal metallization of the switching device 876 is operable as a thermal and mechanical bridge between the heat sink 844 and the circuit board 842. The heat sink is effectively connected to the circuit board 842 by the triac 876, which also eliminates the need for separate mounting hardware to mount the heat sink, thereby increasing production efficiency. The copper plate 844 is sized such that it has a relatively large surface area to effectively dissipate heat through the potting and sensor housing (not shown) and into the external environment. Preferably, the heat sink is located near the lower end of the housing so that it is more likely to be located below the liquid level. This way, heat produced by the circuit is transferred to the liquid. As a result, heat may be dissipated through the housing much more effectively, because liquid is a much better thermal conductor than air.

It should be noted that different applications and conditions may require the sensor and related components to be manufactured from different materials. For example, the materials used for the power cord and the potting for standard applications (such as sump applications) were found to be less suited for sewage applications. PVC or thermoplastic jackets used on power cords in testing were found to fail tests required to obtain sewage rating under applicable UL requirements. Upon experiment, it was found that rubber or thermoset jackets were preferable to PVC for sewage applications. In addition, the protective material, such as potting, used to protect the electric circuitry of the sensor in standard applications was less suited for sewage applications. However, no potting material suitable for a sewage application could be found that had the desirable flammability rating to meet UL requirements. Therefore, after much experimentation, it was found that using two different potting compounds arranged in layers was effective to meet both flammability and sewage requirements. Therefore, in a preferred form for sewage applications or other applications with similar conditions, the sensor electrical components are first covered with a first potting compound, and then a second potting compound is disposed on at least a portion of the first potting compound. The first potting material is preferably a flame retardant compound, such as EL-CAST FR resin mixed with 44 hardener, manufactured by United Resin. The second potting compound, which forms an outer layer disposed on the first, is preferably an acid-resistant potting compound, such as E-CAST F-28 resin mixed with LB26X92A hardener, also manufactured by United Resin. Thus, in a preferred form, the sensor housing is partially filled with the flame retardant potting compound, and then the second, acid resistant compound is poured into the housing such that the second layer is formed having an approximate thickness in the range of about ⅛ to ¼ inch. As mentioned above, in another form, the second potting compound may be the same composition as the first potting compound. In yet other forms, one or more protective materials effective to protect circuit components may be used as alternatives to one or more potting compounds, as would be apparent to one skilled in the art.

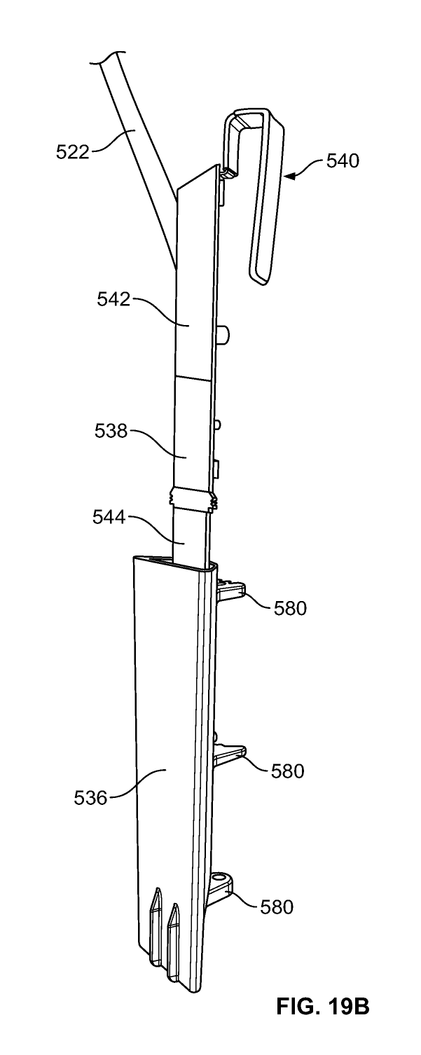

In one example of a typical sump application, the capacitive sensor may be implemented in a conventional battery back-up system. The purpose for the battery back-up in this instance is to allow the pump to continue to pump fluid even when main power is out in a residence or commercial facility. Thus, if the power did go out, the battery back-up system would supply power to the pump so that fluid could be evacuated in order to prevent flooding. Such systems also often include alarms that alert individuals to unusual pump operation, such as high water conditions, continuous running of the pump, overheating pumps, low battery, etc. These alert systems can be hard wired between the pump system and a display or can be wirelessly connected using a transmitter and receiver setup. Typically, the hard wired systems use telephone cable 922 (see FIG. 17) for connecting the pump system to the display and the wireless systems use radio frequency transmitters and receivers. In alternate embodiments, however, other types of cable may be used to hard wire the alert system and other types of convention wireless transmission techniques can be used such as infrared, Bluetooth, etc. In yet other embodiments the wireless system may be connected to a network, such as a LAN or WAN network, so that alerts can be sent via a local area network such as a server or a wide area network such as the Internet.

In another embodiment illustrated in FIG. 17, the capacitive sensor may be used in a dual pump system 900, such as one having primary and backup pump systems 902, 904. The primary pump system 902 may include a first pump 906 acting as the primary pump, a liquid level sensor, such as a capacitive sensor 908 as described in detail above, and a wired or wireless transmitter for communication with a remote receiver 910 of the pump system 900. The backup pump system 904 includes a second pump 912 acting as a backup, in case of either the failure of the first pump 906 or a power outage as discussed above. The secondary pump 912 is preferably battery-operated, such as a 24-volt direct current (DC) pump. The backup pump system may also include a battery bank or back-up 914 for powering the secondary pump 912, a battery charger 916, a float switch 918, a transmitter 920 and a backup pump controller. The backup system 904 may operate by turning on the secondary pump 912 whenever the liquid level triggers the float switch 918, which is normally placed above the regular high liquid level setting of the primary pump 906. Thus, the backup pump 912 is triggered whenever the liquid raises high enough to trigger the float switch 918, which occurs when the primary pump 906 is not pumping liquid at a sufficient flow rate, such as when the primary pump 906 lacks power or is inoperable, clogged, frozen, etc.

The pump system 900 may include an alert system, which includes the remote receiver 910. The remote receiver 910 may be wired or wireless, and is operable to receive information about the status of the system 900 from one or more transmitters of the system and indicate to the user various system conditions, such as when the primary pump 906 has no power or the liquid sensor (such as the capacitive sensor 908) is sensing a high water level, when the backup pump 912 is running or inoperable, when the battery 914 is low, or when the float switch 918 is sensing high liquid level. In addition, the receiver 910 may indicate when its own battery power is low or dead, or when the receiver 910 has lost AC power. The features described above are meant for illustrative purposes only, as one of ordinary skill in the art would contemplate the numerous applications in which the capacitive sensor described above could be implemented.

In addition, the capacitive sensor discussed herein may be implemented with pumps having known features such as cast iron impellers, top suction intakes, carbon/ceramic shaft seals, and stainless steel motor housing and impeller plates. Further, the sensor may be implemented with pump systems having features such as automatic battery recharging, battery fluid and charge monitors, and controls to automatically run the pump periodically to ensure operation. These and other items are disclosed and claimed in prior pending U.S. patent application Ser. No. 12/049,906, filed Mar. 17, 2008, which claims benefit of U.S. Provisional Application No. 60/919,059, filed Mar. 19, 2007, which are both hereby incorporated herein by reference in their entirety.

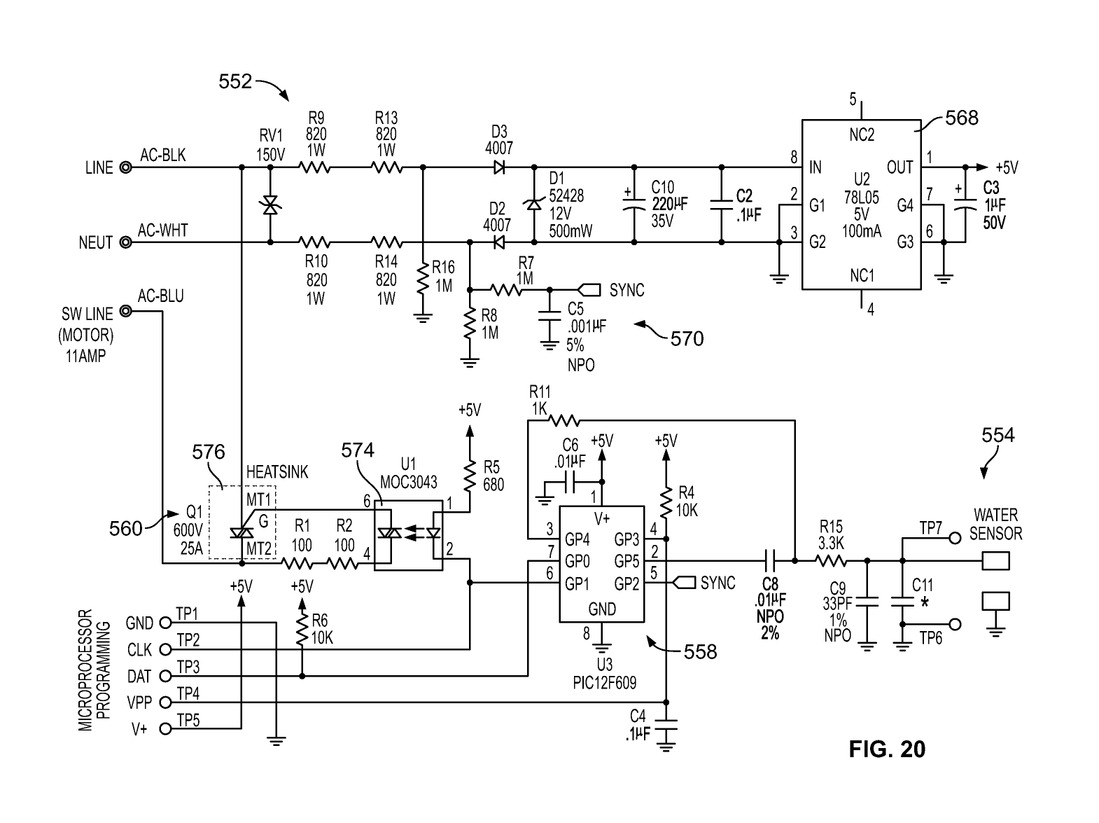

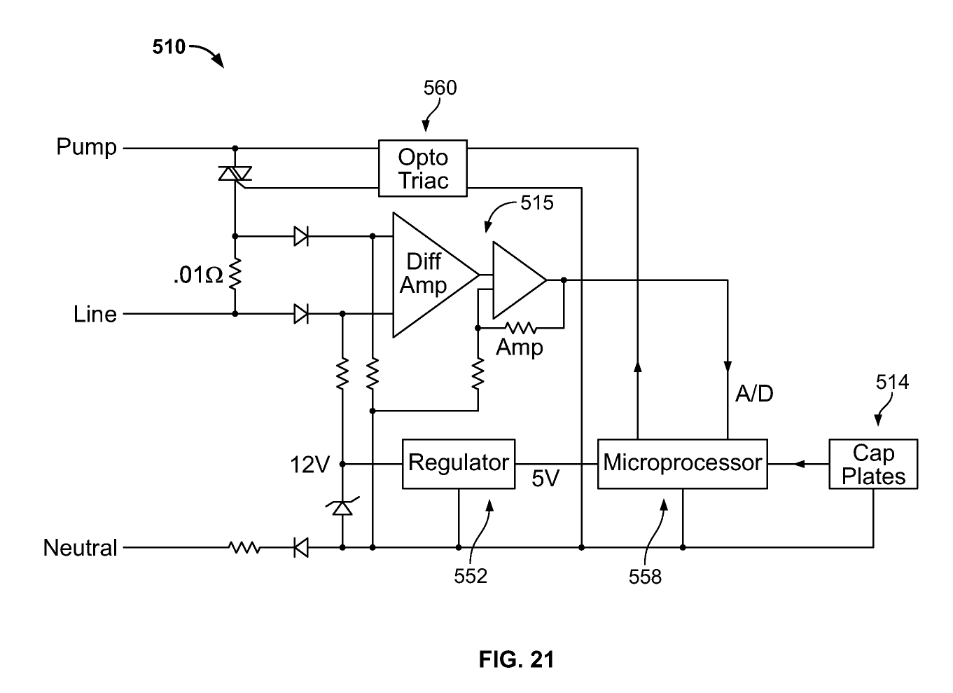

Turning now to FIGS. 18 and 19A-B, there is shown an alternate form of a pump sensor which is similar to that of the sensor 314 of FIGS. 13 and 14A-D. For convenience, features of this embodiment that correspond to features already discussed with respect to the embodiments of FIGS. 1-17 are identified using the same reference numeral in combination with the prefix “5” merely to distinguish one embodiment form the other.

In this form, the detection electrode 40 has been moved to an external position outside of sensor housing 536 to form an external detection electrode or probe 540 (or has been replaced with such an external detection electrode or probe 540). At least a portion of the external detection electrode 540 or the connection that connects it to the sensor 514 extends out of the fluid within which the sensor 514 is immersed to create a gap between the detection electrode 540 and housing 514 within which the reference electrode 538 is disposed to prevent the buildup of conductive materials between the reference electrode 538 and the detection electrode 540 for sensor 514, or at least minimize the effect of same. For example, in some environments containing highly conductive fluids or fluids with entrained or dissolved minerals therein that are conductive, such as for example sewage applications or other pump applications where conductive materials such as minerals can form between the capacitor electrodes, the remote or external positioning of electrode or probe 540 reduces the likelihood that conductive particles will collect between the terminals and thereby affect the ability of the capacitor, sensor and/or pump control to accurately measure capacitance based on the level of fluid making up at least a portion of the dielectric.

More particularly, in some environments containing such conductive fluids, minerals can collect between the reference electrode 538 and the detection electrode 540 of sensor 514 creating a bridge, such as salt bridge 511, between the two electrodes which can interfere with the ability of sensor 514 to determine when the pump 312 (FIG. 13) should be turned on and/or off and may result in the pump 312 operating continuously or nearly continuously when in fact the high water position 30 (FIG. 1) has not been reached and the pump does not need to be operating. Thus, by moving the detection electrode 540 outside of the housing 536, separating it from the reference electrode 538 and creating a connection between the detection electrode 540 and the reference electrode 538 that extends above the fluid within which the sensor 514 is immersed, the sensor 514 eliminates the possibility that (or at least greatly reduces the likelihood that) minerals will collect to form a salt bridge between the reference electrode 538 and detection electrode 540. This configuration allows the sensor 514 to function as desired in highly conductive fluids and the ability to function correctly when the sensing surfaces have been coated with an electrically conductive film on the surface of the sensor 514 or between the electrodes 538 and 540.

For convenience, the reference electrode 538 and original detection electrode 40 are shown in broken line to illustrate their approximate location on the inner wall of the sensor housing 536. It should be understood, however, that these electrodes are positioned on the rear side of circuit board 542, adjacent the inner wall of the sensor housing 536 and that the salt bridge 511 actually forms on the outer wall of the sensor housing 536 (which is a part of the dielectric of the capacitive sensor 514 as discussed above). Although this form is illustrated with the detection electrode 540 moved outside of or external to the capacitive sensor housing 536 it should also be understood that in alternate embodiments the reference electrode 538 could be moved outside of the sensor housing 536 instead of the detection electrode 540 or two separate housings could be provided for each electrode 538, 540 with a gap or spacing between the separate electrode housings. It should also be understood that in alternate embodiments the circuit to which the electrodes are connected does not need to be located in the same housing as either of the electrodes. For example, in an alternate form, the sensor 514 may be configured with the circuit located outside of the fluid and the two electrodes in their own respective housing, with the reference electrode housing being immersed in the fluid and the detection electrode housing being positioned separate and apart from the reference electrode so that it is at least partially immersed in the fluid as the fluid reaches the maximum desired fluid level. In yet other forms, the circuit and reference electrode may be positioned within the housing of pump 312 with the detection electrode located in its own housing positioned separate and apart from the housing of pump 312.

As with the embodiment illustrated in FIGS. 13-14D, the sensor 514 is connected to the pump 312 via a plurality of mounting brackets 580. Furthermore, although a hollow housing 536 is illustrated so that the circuit board 542 may be seen, the housing 536 will preferably be filled with a potting material to protect the circuit and components on the circuit board 542 from the liquid in which the sensor 514 will be disposed and/or to hold the circuit board 542 in place inside housing 536. In addition, in a preferred form, the reference electrode 538 will be positioned proximate to the inner wall of housing 536 such that no air gap is formed between the electrode 538 and the housing wall 536. For example, in the form illustrated, the reference electrode 538 is positioned adjacent the inner wall of housing 536 such that it abuts the inner wall of housing 536 over a large portion of its surface area.

Likewise, as discussed above, in a preferred form a portion of the switch 76 (e.g., high current triac 576 in these figures), is mounted to the circuit board 542 and to a heat sink, such as copper plate 544, to prevent the switch 576 from overheating. The heat sink is attached to the triac 576 using a surface mount reflow process and, in effect, the heat sink is effectively connected to the circuit board 542 by the triac 576. The copper plate 544 is preferably sized such that it has a relatively large surface area to effectively dissipate heat through the potting and sensor housing 536 and into the external environment. In one form, the heat sink is preferably located near the lower end of the housing 536 so that it is more likely to be located below the lower fluid level 32 (FIG. 1) of the environment and the heat produced by the circuit is transferred from the heat sink 544 to the liquid within which the pump is immersed. As a result, heat may be dissipated through the housing much more effectively, because liquid is a much better thermal conductor than air.

In the embodiment illustrated in FIGS. 18-19B, housing 536 defines a vertical longitudinal axis and the external probe 540 is in the general form of an inverted U or J-shape and is made of conductive material such as metal and has an insulative polymer coating such as a plastic or rubber coating. The inverted J-shape allows the external probe 540 to extend upward out of a top opening in the upper portion of housing 536 and outward from the sensor housing 536 and back down toward the lower portion of the housing 536 generally parallel to the exterior surface of housing 536 while maintaining a generally constant spacing or gap between the external probe 540 and the exterior of the housing 536. With this form, the upper most portion of the external probe 540 remains out of the fluid within which the sensor 514 is inserted so that only the distal end of the external probe 540 extends back down into the fluid (or at least extends into the fluid when the fluid is approaching or at the high fluid mark 30 depicted in FIG. 1). Thus, with this design, there is no portion of housing 536 located between the electrodes 538 and 540 upon which minerals could deposit to form salt bridge 511.

In the form illustrated, the originating end 540a of probe 540 has a male terminal or connector for mating to a female coupling or connector 541 located on and electrically coupled to the circuit on the printed circuit board 542. Thus, with this form, even existing sensors made to the specification of the sensor depicted in FIGS. 13-14D can be retrofitted with the external probe 540 of sensor 514 so that the original detection probe 40 can be disconnected and/or the electrical circuit can be re-routed to electrically connect to the external probe 540 instead of original probe 40 to prevent mineral buildup between the electrodes 38 and 40. Once the circuit board 542 is inserted into the cavity defined by housing 536 a filler such as potting compound may be inserted into the cavity to seal and protect the circuit 542 and electrical components thereon from the fluid of the surrounding environment that sensor 514 is used in. In a preferred form a standoff, such as a foot member, may be used to maintain spacing of the external probe 540 from the wall of sensor housing 536 so that the probe 540 is adequately surrounded by potting compound and to prevent the probe 540 from coming in contact with the housing 536 so that no mineral buildup or salt bridging can form between the electrodes 538 and 540. The standoff can be positioned on either the inner wall of the housing 536 or on the external probe 540 itself. For example, in a preferred form a foot member or protrusion is positioned on the initial vertical portion of the probe 540 extending up from the male terminal of originating end 540a to space the probe 540 from housing 536. This protrusion is positioned low enough on the probe to ensure that it will be fully encapsulated by the potting compound so that no external portions of the probe 540 and the housing 536 are in physical contact with one another. The probe 540 then continues to extend up vertically from the top opening of the upper portion of housing 536 and then bends out over the edge of the sensor housing 536 and back down at its terminal end toward the lower end of housing 536, generally parallel to the exterior surface of housing 536. This allows the terminal end of the probe 540 to be immersed in the fluid, but to maintain a portion above the fluid to ensure physical separation between the electrodes 538 and 540.

It should be understood that the external probe 540 may be designed in a variety of different shapes and sizes in accordance with the embodiment discussed in FIGS. 18-19B so long as the probe is located remote from or external to the housing 536 and designed with a least a portion of the probe 540 or connection between the probe 540 and sensor 514 extending above the high fluid level 30 (FIG. 1) of the fluid within which the sensor is immersed so that minerals do not collect between the detection electrode 540 and the reference electrode 538. For example, in one embodiment the probe 540 may consist of nothing more than a metal plate located at the distal end of a mount or bracket in the same shape of the probe illustrated in FIGS. 18-19B. Similarly, in alternate embodiments the external electrode or probe 540 may not only take on different sizes or shapes but may also be mounted in a variety of different ways and to a variety of different objects and surfaces, such as the sensor 514, the pump 312 (FIG. 13), the discharge valve 216 (FIG. 12) or other structures in the environment within which the sensor 514 is inserted. For example, in the form illustrated in FIGS. 18-19B, the external sensor 540 is directly mounted to the sensor 514. In an alternate form, the external sensor 540 may be mounted elsewhere on the pump 312 and simply wired to the circuit board 542 of sensor 514. In yet another form, the external sensor 540 may be mounted to the discharge pipe 216 (as the sensor 214 was in FIG. 12). In still other forms, the external probe 540 may be mounted to a wall of the reservoir 26 illustrated in FIG. 1 and electrically connected to the sensor 514 either by insulated wire or some other conventional form of electrical connection.

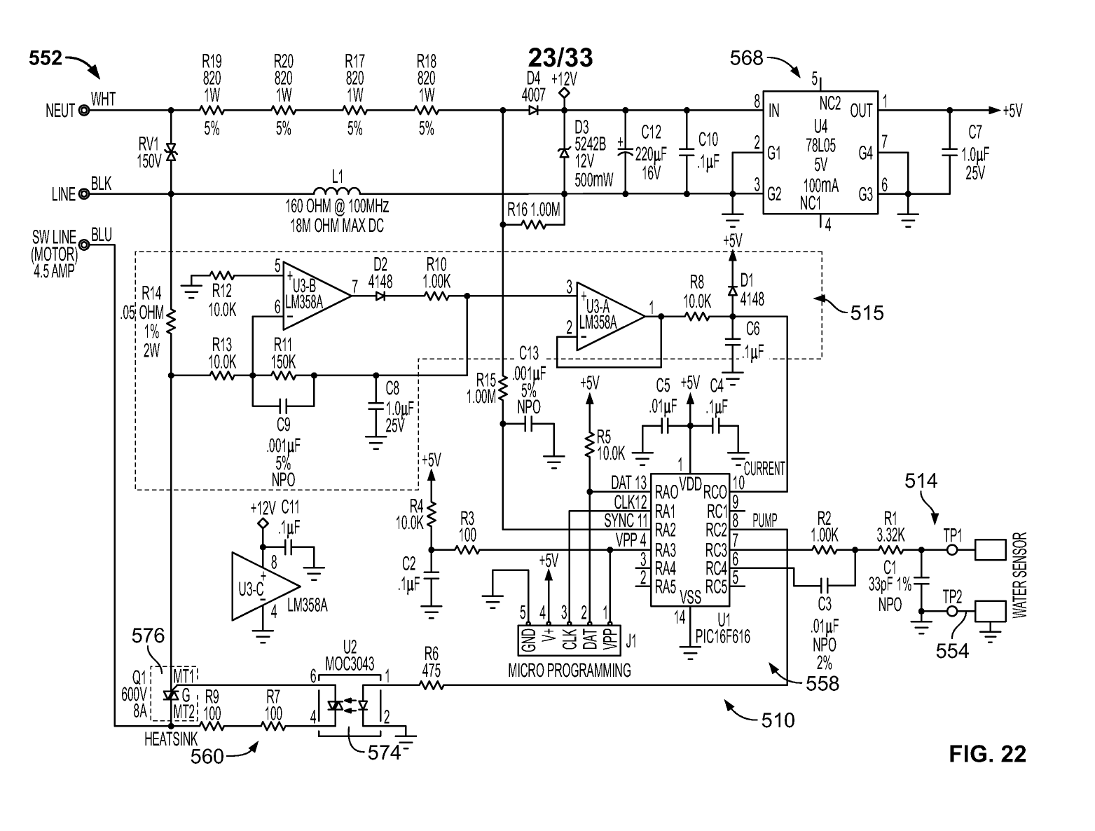

In FIG. 20, a schematic diagram is illustrated of an alternate circuit for sensor 514. In this form, the circuit on circuit board 542 includes a power supply 552, a capacitive sensor 554, a controller, such as microcontroller 558, an AC switch 560, and signaling circuitry 570. The capacitive sensor 554 tells the controller 558 when to turn the pump 312 on and the controller 558 turns on the pump 312 via the opto-triac 574 and high current triac 576 which supplies AC power to the pump 312. The operation of the circuit is very similar to that of the circuit described above with respect to FIGS. 4A-5, but in this circuit the separate microcontroller 58 and sensor IC of cap sensor 54 in FIG. 4A have been combined into one microcontroller 558. In a preferred form, the controller 558 is programmed to activate the pump 312 for a minimum of four seconds and a maximum of sixteen seconds. Additionally, the controller 558 is programmed to insure deactivation of the pump 312 for a minimum of one second between activation and deactivation. It should be appreciated, however, that such specific activation and deactivation periods are merely exemplary and that the controller 558 may be programmed to accommodate various different sizes, models and configurations of pumps 12 and, therefore, these timings may also be changed to satisfy the desired conditions for any given application.

It should be understood, however, that in alternate embodiments the circuit could be programmed to operate in any of the different manners discussed above (e.g., as described with respect to FIG. 6, FIG. 7, etc.) or as contemplated herein. For example, the circuit could be programmed to operate the pump 312 until a predetermined lower limit capacitance is detected indicative of the low water level 32 (FIG. 1), or to determine a run-time that the pump 312 should be operated for, or to determine a flow rate based on the amount of fluid that has been evacuated by the pump 312 over a period of time in order to determine a pump operation period, etc. Similarly, it should be appreciated that while the above-described processes have been described as including a series of actions described according to a sequence of flow chart steps, the present invention is not intended to be limited to any specific order or occurrence of those actions. Specifically, the present invention is intended to provide options for end product designers and allow for variations in the sequences at which the above-described actions are performed, as well as additional or supplemental actions that have not been explicitly described, but could otherwise be successfully implemented.

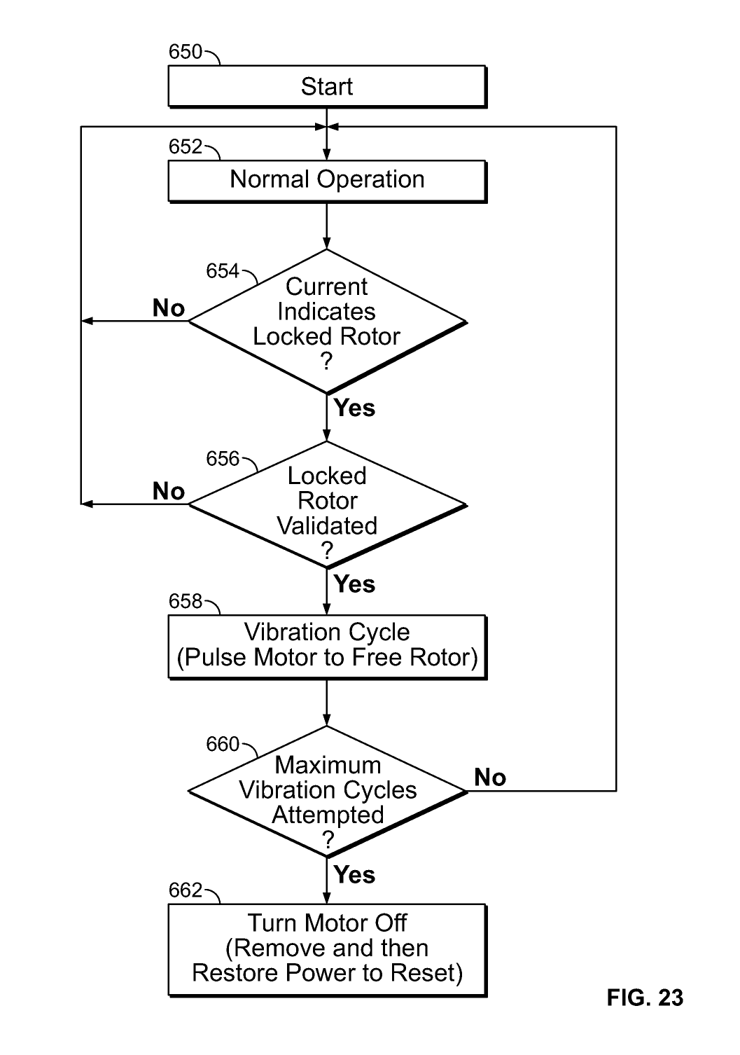

In yet another form of the invention, however, the pump control 510 may be designed to actuate the pump 312 using a first type of sensor and to turn off the pump using a second type sensor different from the first. For example, in the block diagram illustrated in FIG. 21, pump control 510 uses capacitive sensor 514 to tell the controller 558 when to turn on the pump 312, but uses a different type of sensor, i.e., current sensor 515, to tell the controller 558 when to turn off the pump. In this form, the controller 558 actuates the pump 312 via AC switch 560 and then waits a very brief amount of time to determine what the normal or base line average current is during the initial pump operation period. The purpose for waiting a brief amount of time after actuating the pump is to account for current stabilization (e.g., waiting half a second or so should account for any initial current spikes that occur from actuating the pump). Then, once the controller 558 detects that the current has changed via current sensor 515, such as for example ten percent below the base line, it is assumed that the pump 312 is running out of fluid to evacuate from the area and thus the controller 558 shuts off the pump 312. An advantage to using current sensor 515 to shut the pump 312 off is that there are no calculations or estimates that need to be made to determine how long to run the pump 312 or how long it will take to evacuate the desired area of fluid. Rather, the current sensor 515 allows the controller 558 to determine exactly when the pump 312 has successfully evacuated the desired amount of fluid from the area and then shut the pump 312 off.

In the current sensor form illustrated, a very small resister is placed in series with a differential amplifier to sense current by monitoring the voltage across that resister. A 0.01 Ohm resister is shown for use in applications utilizing a 5-10 Amp motor. This 0.01 Ohm resister will give 100 mV of signal for a 10 Amp current which is within the desired range voltage signal. In other forms, alternate resister values may be used to ensure that the differential amplifier of current sensor 515 is triggered once the desired current has been reached. For example, a 0.020 or 0.025 Ohm resister may be used for a 3 Amp motor driven pump. Thus, the components selected will preferably be determined based on the size of the motor that is to be used in conjunction with the sensor and pump control. In addition to what is shown in the block diagram of FIG. 21, a rectification circuit could be used in conjunction with the op amp located behind the differential amplifier in order to convert the AC signal to a DC voltage. Alternatively, given how fast microprocessors have become, the AC voltage could be measured at its peak at a zero crossing without needing to rectify the signal. Once the current sensor indicates a ten percent decrease in current from the base line current average, the controller 558 determines the low fluid limit has been reached and shuts off the pump 312. It should be understood, however, that the pump controller 510 of FIG. 21 may be configured to operate at different ranges or with different values and limits. For example, some highly efficient motors might show the current change as a fifty percent reduction or more when the low water limit has been reached while other shaded pole motor may only show a ten percent reduction. Thus a reduction in excess of ten percent may be used to trigger the controller to shut of the motor on one application while a reduction of anywhere between ten to seventy-five percent may be used to trigger the controller to shut off the motor in other applications.

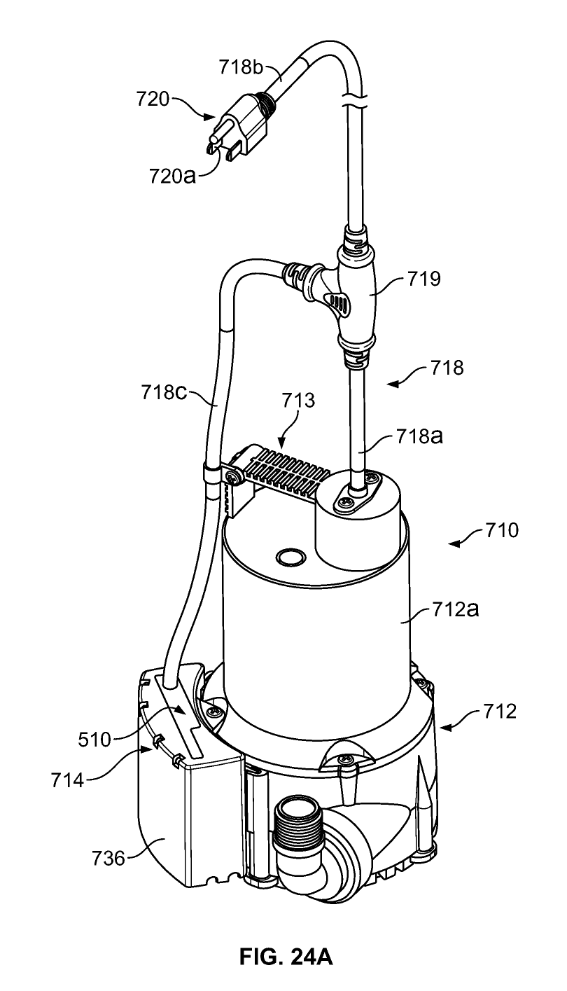

A detailed circuit schematic of one embodiment of the pump control 510 of FIG. 21 is illustrated in FIG. 22. In this embodiment, the controller 558 uses the capacitive sensor 514 to detect when a high fluid level has been reached and activates the pump via AC switch 560. The controller 558 then uses the second sensor, which in this embodiment is current sensor 515, to detect when the pump has evacuated a sufficient amount of fluid and deactivates the pump via AC switch 560. In the form illustrated, a 0.05 Ohm resister is placed in series with the differential amplifier and the voltage across this resister is monitored by controller 558 to determine the amount of current being drawn by the pump motor. When the pump evacuates fluid down to the level of the pump inlet, air will enter the pump. Air, being less dense than the fluid, will result in the pump motor drawing less current. Once the controller 558 detects that the current has dropped to a level indicative of a low fluid level, the controller 558 will shutoff the pump via the AC switch 560. What that current level will be will largely depend on the size of the pump used (e.g., size of motor, etc.) and/or the application for which the pump is designed (e.g., sump applications, effluent applications, etc.).

The controller 558 can be programmed to turn off the pump when the predetermined current level has been reached either once or over a plurality of times or when an average of the current readings has reached a predetermined current level. For example, in one form, the controller 558 may be programmed to shutoff the pump the moment the current drops to a value that is a predetermined percentage below the normal operating current for the pump. This could be setup so that the moment this actual current value is detected the controller shuts off the pump. Alternatively, it could be setup so that the actual current value is setup as a threshold and any reading at that value or below causes the controller 558 to shutoff the pump. In yet other forms, the controller could take a plurality of readings and wait until the average reading over a certain number of samples is at or below the predetermined threshold current. In a preferred form, the controller 558 is programmed to shutoff the pump after a predetermined number of current readings come in at or below a predetermined threshold value.

In still other forms of the invention, a first capacitive sensor may be used to turn on the pump and a second sensor, such as a thermal or temperature sensor, may be used to turn off the pump via the detection of heat indicative of the pump having evacuated enough fluid from a reservoir or space. For example, a thermal sensor may be used to detect the fact that the pump is running hotter because it has evacuated all or most of the fluid it was activated to evacuate. Once this rise is temperature is detected (or a predetermined temperature is reached), the thermal sensor would tell the controller to shut off the pump and the pump would remain off until the capacitive sensor tells the controller to activate the pump again. Examples of thermal or temperature sensors that may be used as the second sensor may be obtained from entities like Maxim Integrated Products, Inc. of Sunnyvale, Calif.

In another form, a first capacitive sensor may be used to turn on the pump and a second sensor, such as a speed or torque sensor, may be used to turn off the pump via the detection of a change in speed indicative of the pump having evacuated enough fluid from a reservoir or space. For example, a speed sensor may be used to monitor the speed with which the impeller of the pump (or impeller shaft) is rotating and upon the detection of a change in the speed of the impeller, may tell the controller to shut off the pump as enough fluid has been evacuated from the space. More particularly, the speed sensor may be used to monitor the speed of the impeller to confirm that it is evacuating fluid as desired. Once the impeller speed starts to increase, it is assumed that the amount of torque has dropped down below a predetermined level due to the lack of liquid for the vanes of the impeller to engage, thereby signaling that enough fluid has been evacuated and the pump may be shut off. The exact amount of speed and/or torque that triggers the shut off of the pump may be selected and varied depending on the type of fluid being evacuated by the pump or in what environment the pump is operating or depending on the size pump or motor being used, etc. For example, a higher speed setting may be monitored for in sump applications than in a sewage application due to the difference in friction or viscosity associated with the different fluids being pumped (e.g., the speed sensor may want to be set for a higher speed setting in sump applications than in sewage applications because gray water is lighter and less frictional or less viscous than sewage and thus a small remaining amount of gray water will likely allow for higher increases in speed than a similar small amount of remaining sewage, etc.). Similarly since torque multiplied by speed equals power, this form of sensor could be described as monitoring for a change in power (instead of describing it as speed or torque monitoring) and de-activating the pump when a certain power change has been detected.

In yet other forms, the controller may be programmed to shut off the pump upon the detection of a predetermined speed or upon the detection of a predetermined torque. For example, if the torque of the impeller shaft has dropped to (or below) a predetermined torque level it may be assumed enough fluid has been evacuated such that the pump may be shut off. Such a sensor is disclosed in U.S. Pat. No. 5,297,044 which is hereby incorporated by reference herein in its entirety. Other examples of speed/torque sensors that may be used as the second sensor may be obtained from entities like Electro-Sensor, Inc. of Minnetonka, Minn.

In still other forms, the second sensor may be implemented as a magnetic sensor, such as Hall Effect sensors. For example, a Hall Effect sensor may be used to detect current and shut off the pump once a specified current is reached as discussed above with respect to FIG. 21. In other forms, Hall Effect sensors may be used to detect motion or speed and to shut off the pump once specified speed is reached as mentioned above. Examples of Hall Effect sensors that may be used as the second sensor may be obtained from entities like Allegro MicroSystems, Inc. of Worcester, Mass.

It should also be understood that the sensors utilized to turn on and off the pump or detect high and low fluid levels may also be used to help the pump control or system to perform other functions or tasks. For example, the sensors employed by the pump control may be used to give a variety of different information. For example, the sensors may be used to signal when a pump malfunction has been detected or when a maintenance condition or repair condition exists. The malfunction or maintenance or repair condition can be any number of things but typically will relate to the type of sensor that is being utilized. Thus, if a capacitive sensor is being used, in addition to signifying high and/or low fluid levels or when the pump should be turned on and off, the sensor may also be utilized to indicate when the capacitive sensor needs to be cleaned or is not working properly. For example, if the controller detects that the capacitance of the sensor is not operating within a normal range of capacitance based on the readings it is getting from the capacitor, the controller may signal that the capacitive sensor is malfunctioning or in need of maintenance or repair. In one form, when such a condition is detected an audible and/or visual alarm may be activated to indicate that the sensor needs a cleaning such as requiring that the outer surface of the capacitive sensor be cleaned or wiped, etc.

Similarly, if a speed or torque sensor is employed, the controller may utilize the readings it is getting from the speed or torque sensor to indicate that a malfunction, maintenance or repair condition exists. For example, if the speed or torque sensor indicate that the motor is not operating within a predetermined range of speeds that are deemed normal, the controller may utilize the readings from this sensor to signal that a malfunction, maintenance or repair condition exists, such as indicating that the motor bearings should be checked or that the motor brushes should be checked, etc.

In another form, if a thermal sensor is employed, the controller may utilize the thermal sensor readings to determine if the pump or pump motor is operating within an acceptable range of temperatures and signaling that a malfunction or maintenance or repair condition exists. For example, if the temperature sensor indicates that the pump motor is operating out of a predetermined range of acceptable temperatures, the controller may use this sensor data to signal via an audible or visual alarm that a malfunction or maintenance or repair condition exists, such as that the motor bearings should be checked or the pump should be checked for a rotor jam or impeller blockage.

In still other forms, if a current sensor is employed in the pump control circuit, the controller may utilize the readings it is getting from the current sensor to signal a malfunction and/or that a maintenance or repair condition exists. For example, if the current sensor is indicating that the motor is drawing too much or too little current with respect to a predetermined range of currents that are deemed to be within normal pump operation, the controller may signal that there is a malfunction (e.g., indicating that the motor needs repair or maintenance). Alternatively, the system may be setup to do a random test of a battery backup system (if applicable) and if the current sensor indicates during that test that too little current is being drawn by the motor or supplied to the motor, the controller may signal that there is a malfunction, maintenance or repair condition, such as by using an visual and/or audible alarm indicating that the battery of the battery backup system should be checked and/or charged.

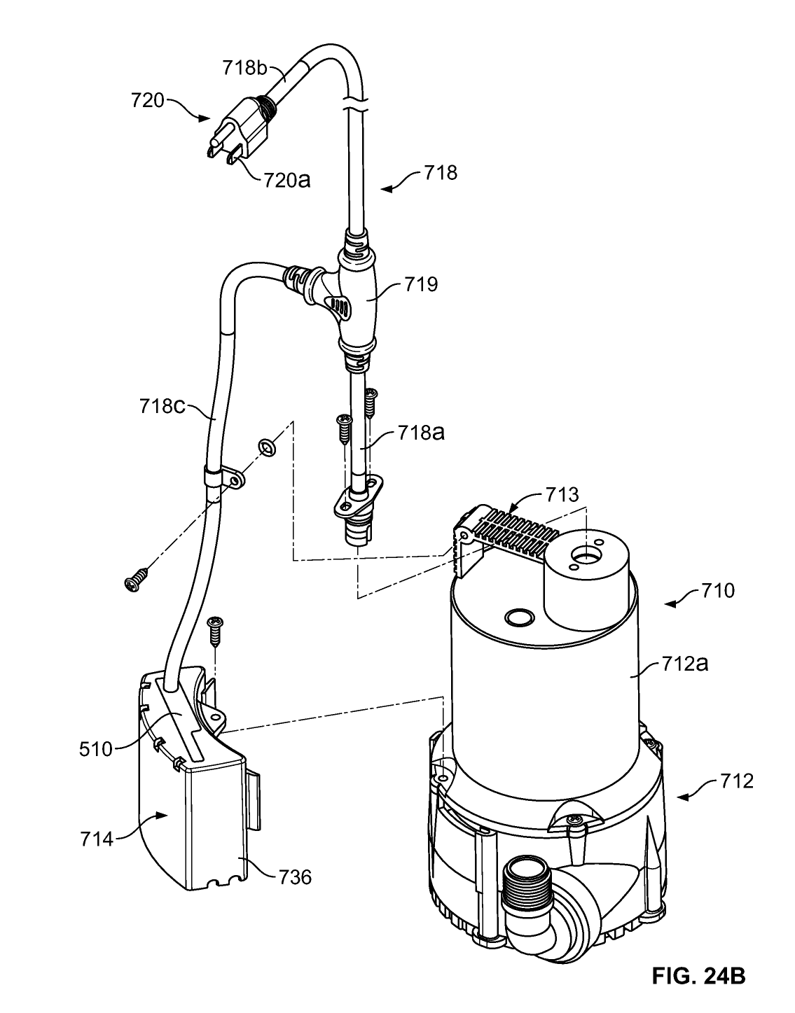

In the pump control illustrated in FIGS. 21-22, the current sensor 515 may be used to signal when a pump malfunction or maintenance or repair condition exists. For example, the controller 558 may be programmed to run routine 650 illustrated in FIG. 23. When so programmed and the controller 558 determines that the pump is operating within normal operation 652 due to the current readings being within a predetermined range of currents associated with normal pump operation, the controller 558 checks to see if the instant or real time current reading 654 indicates that a locked rotor condition exists (e.g., if the current is above the range of currents associated with normal operation and possibly at or above a threshold current indicative that the rotor is locked or the impeller is blocked with an obstruction. If the instant or real time current reading does not indicate that a locked rotor condition exists, the controller returns to the beginning of routine 650 and normal operation 652.

If the instant or real time current reading indicates that a locked rotor condition does in fact exist, the controller stops and starts the pump 656 to validate if a true locked rotor condition exists. If so, the controller cycles or pulses the motor on and off 658 to vibrate or jar the motor in an effort to free the rotor or unblock whatever impeller obstruction might be present and causing the high current reading. If the maximum number of cycles or pulses have not been attempted 660, the controller returns to the beginning of the routine 650 and normal operation 652. If the maximum number of cycles or pulses have been attempted, the controller turns off the motor 662 and signals that a malfunction or maintenance or repair condition exists. In a preferred form, the controller signals that a malfunction or maintenance or repair condition exists by shutting off the pump and requiring the pump to be unplugged and plugged back in to restore power to pump.

In one form, the pump controller is programmed to consider any current between the range of 1.5 A-2.5 A as being within normal operating parameters for the pump and/or pump control. If the current sensor indicates a current of 3 A or higher, the pump control will assume that a locked rotor condition has developed, (e.g., such as when an obstruction has blocked rotation of the impeller), confirm or validate that the locked rotor condition still exists after a period of time and then vibrate or cycle the motor on and off for a period of time in an attempt to either breakup or dislodge the obstructions and return the pump to normal operation. If the rotor or impeller is not freed within a predetermined amount of time, the pump control will deactivate the pump in which case the end user will have to unplug the pump from the power source to reset the pump control before the pump can be activated again.

In a preferred form, the pump control will also signal that a malfunction has occurred and/or that maintenance or repair is needed. The signal may be any audio and/or visual alert to draw the attention of the end user. For example, in one form the pump control will activate a buzzer or speaker of some sort and illuminate a light emitting diode (“LED”) or other indicator to indicate that a malfunction has occurred and/or that maintenance or repair is needed. In alternate embodiments, other forms of signaling may be used. In fact the vibrating or cycling of the pump on and off may itself serve as the signal that a malfunction has occurred and/or that maintenance or repair is needed. Alternatively the shutting off of the pump and disabling the pump thereby requiring resetting of same may be used as the signal that a malfunction has occurred and/or that maintenance or repair is needed. In still other forms, the pump control may signal the malfunction and/or need for maintenance or repair by transmitting a signal via a circuit, network or wirelessly to alert the end user in some manner that a malfunction has occurred and/or that maintenance or repair is required. In this way, the pump control is capable of conducting its own self diagnostics check and alerting the end user when the pump is operating outside of its normal operation parameters to indicate a malfunction and/or the need for maintenance or repair.

It should be understood that in alternate embodiments, the pump control may be programmed with a different range of current that is considered to be the normal operating range of currents and/or a different threshold current for triggering some action to either attempt to return the pump to its normal operation or signal a malfunction and/or the need for maintenance or repair. The size of the pump, the pump motor and/or the application for which the pump is intended to be used (e.g., is it a effluent pump, a sump pump, a irrigation pump, etc.) are all factors that will determine what range of current is deemed normal operating current and what threshold current should be used to trigger the above mentioned sequence of events or actions. For example, the physical size of the pump, the motor operating parameters (e.g., current draw, horse power of the motor, etc.) and the fluid the pump is being used to move all may factor into what current range is set as the normal operating current and what threshold current level will be used as the trigger for the above mentioned actions.

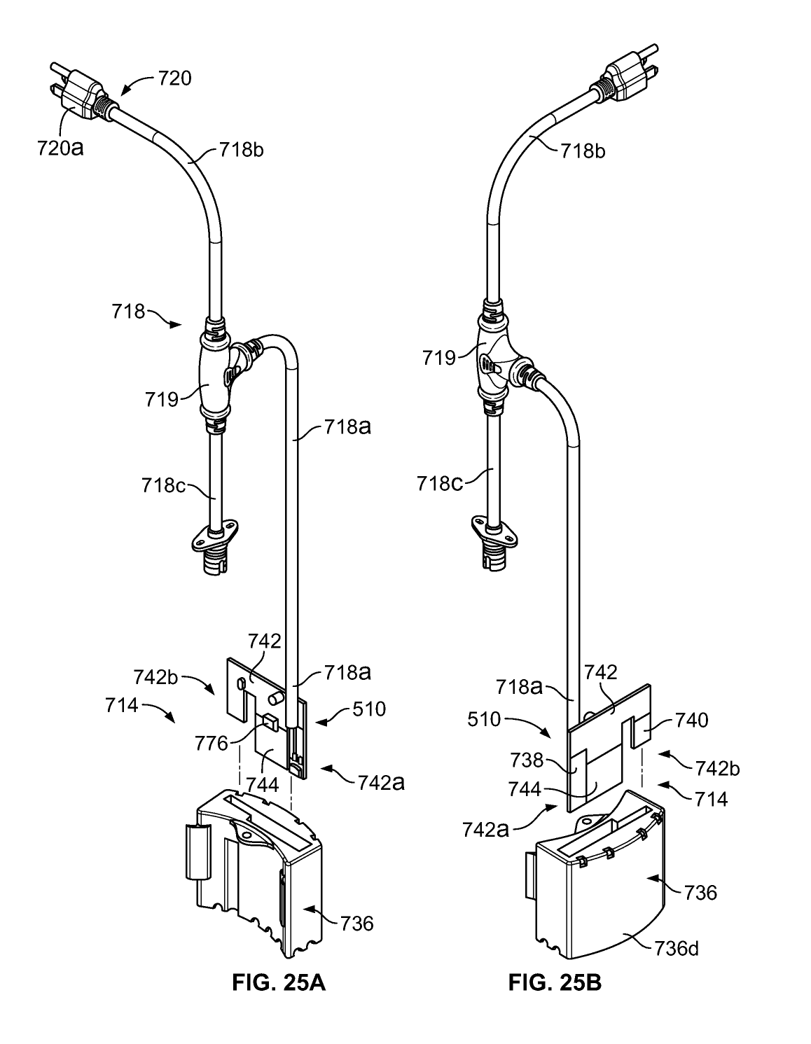

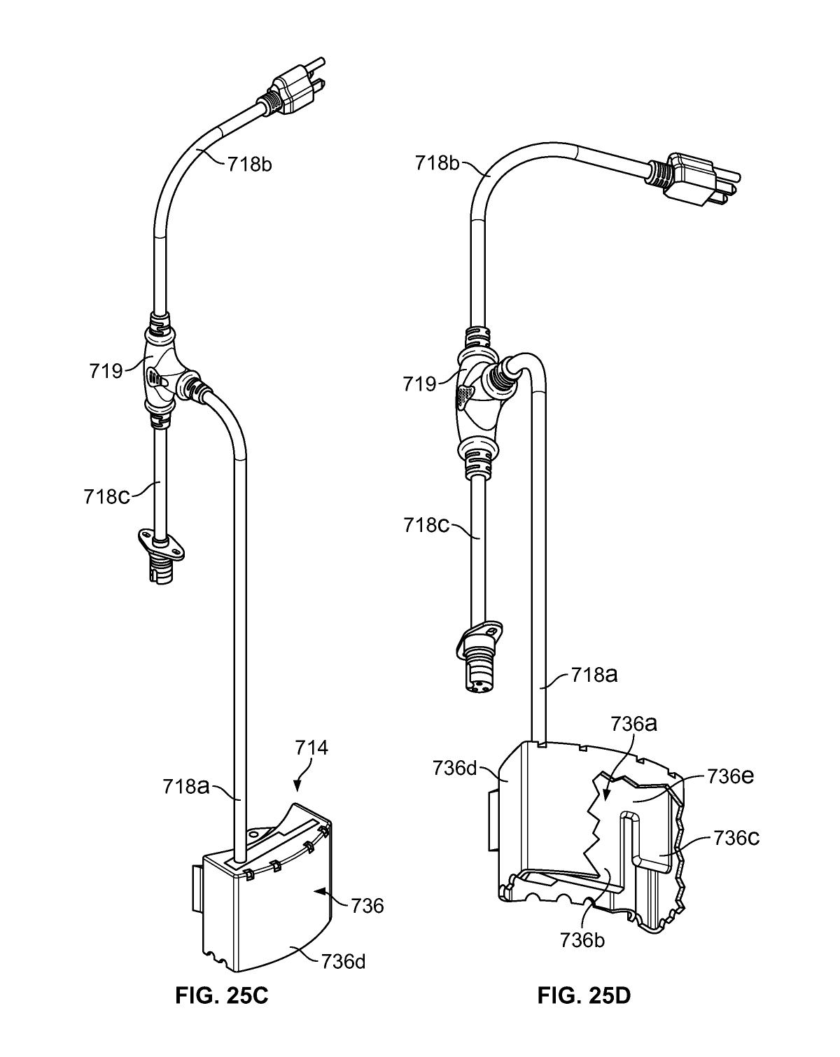

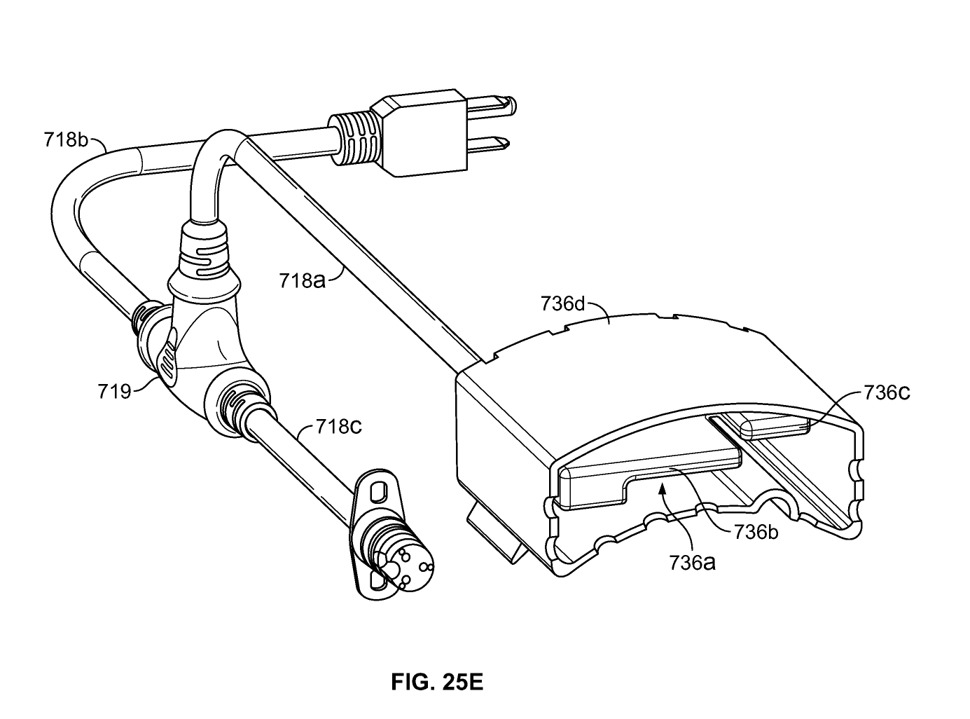

In FIGS. 24A-25E, there is illustrated yet another embodiment of a pump control and pump system in accordance with the invention. In keeping with prior practice and for convenience, features of the alternate embodiments of the pump control and system illustrated in FIGS. 24A-25E that correspond to features already discussed with respect to the prior embodiments discussed herein (e.g., embodiment of FIGS. 1-7, embodiment of FIGS. 8-11, embodiment of FIGS. 12-14D, etc.) are identified using the same reference numerals used in FIGS. 1-7 in combination with the prefix “7” merely to distinguish one embodiment from the other, but otherwise such features are similar. In this form, sump pump system 710 includes a pump 712 powered by a motor 784, a sensor unit 714, and a liquid discharge pipe (not shown). The pump 712 has an outer pump housing 712a that defines a cavity within which the motor 784 is disposed, a pump chamber or volute within which the impeller is disposed, and utilizes a circuit like that illustrated in FIGS. 21-22.

In the form illustrated, the sensor unit 714 has a pump control 510 that utilizes a capacitive sensor 514 for determining when a high fluid level has been reached. The sensor 714 includes a sensor housing 736 defining a first cavity 736b and a second cavity 736c connected to the first cavity 736b via bridging member 736e which spaces the second cavity apart from the first cavity thereby creating a gap therebetween. The capacitor 514 has a first electrode 738 disposed within the first cavity 736b of the sensor housing 736 and a second electrode 740 disposed within the second cavity 736c of the sensor housing 736 thereby creating a gap between the first and second electrodes 738, 740. The gap or spacing between the first and second cavities 736b, 736c and electrodes 738, 740 helps reduce the risk of mineral buildup (such as the salt bridging discussed above) occurring between the first and second electrodes 738, 740. A dielectric is formed between the electrodes 738, 740 to complete the capacitor 514 and allow the controller 558 to detect or read capacitance with the capacitive sensor. The dielectric includes a first part made of an insulative material and a second part made of at least a portion of the fluid or liquid within which the pump 710 is disposed. Since the fluid has a level that changes with respect to the insulative material of the dielectric and the capacitor's electrodes 738, 740, the capacitance of the capacitor 514 will change as the level of the fluid changes (as discussed above).

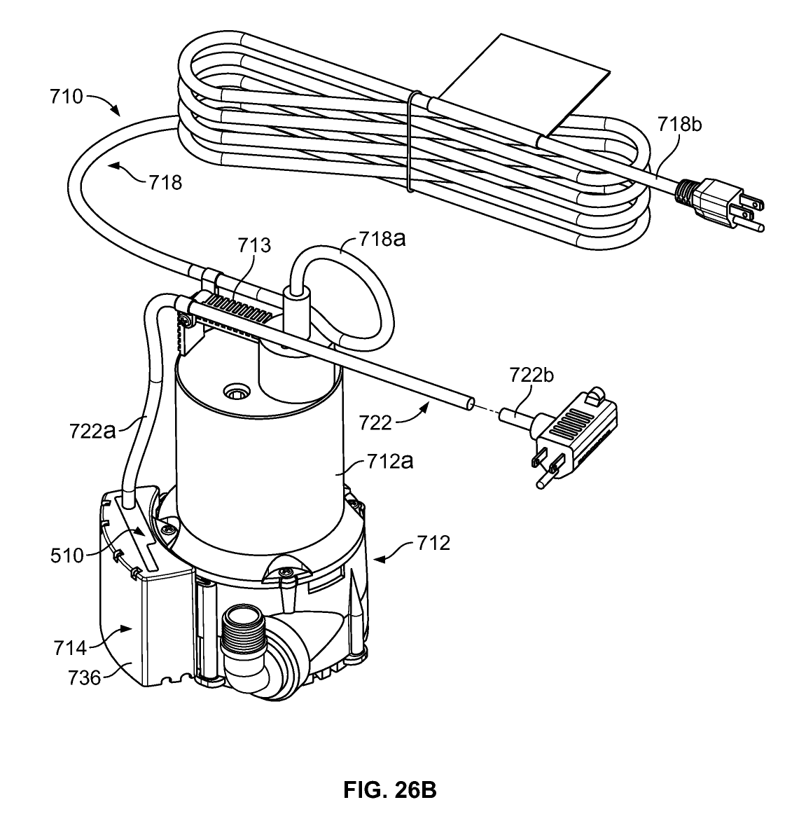

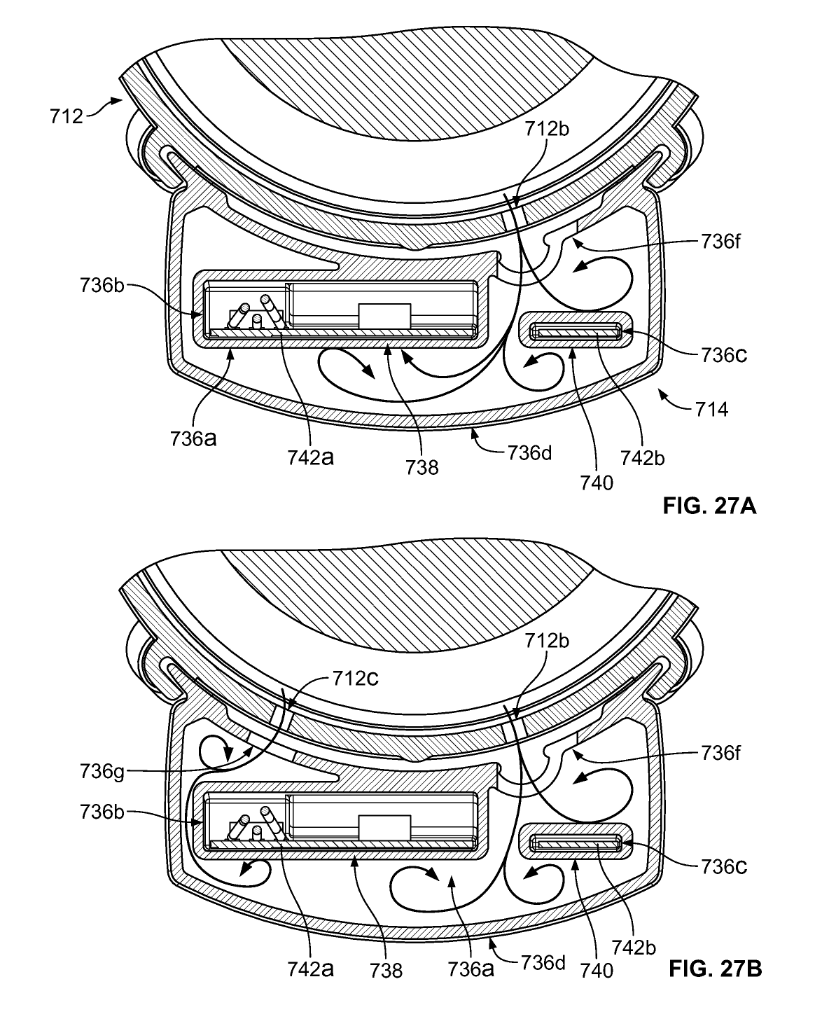

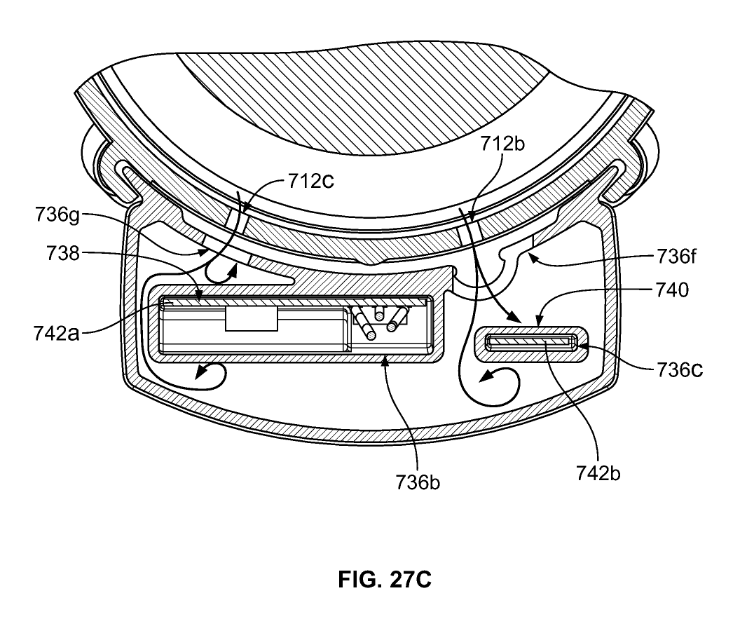

In a preferred form, at least a portion of the sensor housing 736 forms at least a portion of the insulative material of the dielectric and the housing 736 is configured and/or positioned such that at least a portion of the first and second cavities 736b, 736c may be disposed in the fluid with the bridging member 736e generally remaining above the fluid in order to prevent mineral buildup between the capacitor electrodes 738, 740. In the form illustrated in FIGS. 24A-25E, the first and second cavities 736b, 736c of housing 736 are defined by an inner or interior wall 736a having a generally upside down U- or J-shaped cross section (see FIG. 25D) and the housing further comprises an outer or exterior wall 736b that surrounds at least a portion of the first and second cavities 736b, 736c and is spaced apart from the interior wall 736a (see FIGS. 25D, 25E and 27A-C) to protect the first and second cavities 736b, 736c and the electronics or components located therein from damage during validation testing or general use of the capacitive sensor 514. For example, during certification or validation testing conducted by several standards associations like UL, CSA, ETL, CE, etc. the system 710 or parts thereof may be subjected to impact tests that are meant to test the durability of the system's components. By spacing the outer wall 736b apart from the inner wall 736a containing the pump control 510, the outer wall 736b can absorb impacts or blows that might otherwise damage the components disposed within inner wall 736a. In this way, the outer wall 736b serves as a bumper or integrated buffer zone that can absorb such blows and protect the pump control 510.

In FIGS. 24A-25E, the pump control 510 includes a controller such as controller 558 of FIGS. 21-22 for actuating or operating the pump 712, which is connected to the circuit 742 via AC switch 560. The circuit 742 is disposed in the pocket defined by housing 536 and filled with a conventional waterproof potting compound so that the pump control 510 can be immersed in the fluid within which the pump 710 is disposed. As discussed above, in a preferred form the switch 776 (or 576 if looking at FIGS. 21-22) is a high current triac mounted to the circuit board 742 and to a heat sink, such as copper plate 744, to prevent the switch 776 from overheating. The heat sink 744 is physically connected to the PCB 742 via triac 776 in a manner similar to that discussed above with respect to triac 576 and is preferably sized such that it has a relatively large surface area to effectively dissipate heat generated by the circuit on PCB 742. As with prior embodiments, the heat sink is preferably located near the lower end of the housing 736 so that it is more likely to be located below the lower fluid level (see 32 in FIG. 1) of the surrounding environment and the heat produced by the circuit is transferred from the heat sink 744 to the fluid or liquid within which the pump is disposed. As a result, heat may be dissipated through the housing much more effectively, because liquid is a much better thermal conductor than air.

The PCB 742 is designed such that a first circuit board portion 742a is disposed in the first cavity 736b of housing 736 to which the first electrode or probe 738 is connected and a second circuit board portion 742b disposed in the second cavity 736c of housing 736 to which the second electrode or probe 740 is connected. In a preferred form, the circuit board portions 742a, 742b are configured and/or positioned such that the first electrode 738 of the capacitor is positioned adjacent an inner surface of the first cavity 736b and the second electrode 740 of the capacitor is positioned adjacent an inner surface of the second cavity 736c so that when the pump control is immersed in a fluid the portion of the housing 736 adjacent the first and second electrodes 738, 740 and the fluid within which the pump control is immersed make up at least a portion of the dielectric between the first and second electrodes 738, 740 to form the capacitor and allow for controller 558 to detect capacitance using same. Furthermore, in the embodiment illustrated, the first cavity 736b and first circuit board portion 742a are positioned in a lower portion of the housing 736 and the second cavity 736c and second circuit board portion 742b are positioned in an upper portion of the housing so that the second electrode 740 is positioned higher than the first electrode 738 and the capacitor sensor can be used to detect a high fluid level in a manner similar to the alternate embodiments discussed above.

As mentioned previously, in a preferred form, the bridging member 736e will remain above the fluid to create the gap between the first and second electrodes 738, 740, thereby preventing mineral buildup between the electrodes 738, 740. As the fluid level changes with respect to the housing 736 the capacitance of the capacitor will also change because of the resulting change this causes to the physical properties of the capacitor's dielectric. The controller 558 will activate the motor 710 of pump 712 when a high fluid position is detected via the capacitance detected from the capacitive sensor as discussed earlier. Unlike the earlier embodiments, however, the pump control 510 further includes a current sensor 515 which is connected to, and monitored by, the controller 558 to shut off the pump 712 when the current sensor 515 detects a predetermined current reading signifying a low fluid position. In the current form, the system is setup to watch for the current to drop below a threshold amount that is indicative of the low fluid position having been reached. More particularly, when the fluid level drops below the inlet of pump 712, air will start to enter the pump. This causes a change in fluid density which ultimately reduces the load on the motor 714. Reduced load translates into the motor drawing less current and, thus, that is why the current sensor looks for a drop in current to determine when the low fluid level or position has been reached.

As mentioned above, it should be understood that the current sensor 515 must be matched to the pump motor's electrical characteristics and the particular attributes of the fluid or application that the pump will be used in conjunction with (e.g., is it a simple sump application or a more heavy duty waste application, etc.). These characteristics and attributes will determine what current range is set for normal operation and what current threshold is set for signifying the low fluid level and triggering the controller 558 to shutoff the pump 712. Further uses of the current sensor may also be made (e.g., detecting rotor jamming, signaling a malfunction or a maintenance or repair condition, etc.).

In the form illustrated, the system 710 is designed with a single power cord 718 that connects the pump motor 714 to the pump control 510 via AC switch 560. The power cord 718 is uniquely designed with a first segment 718a connected to the pump on one end and to a waterproof joint 719 on the other end, a second segment 718b connected to the waterproof joint 719 on one end and a conventional power plug 720 on its other end, and a third segment 718c that connects to the waterproof joint 719 on one end and the pump control 510 on the other end. As best seen in FIGS. 24B and 25A-E, the first segment 718a is connected to the pump using a conventional waterproof connector that is fastened to the pump 712. The second segment 718a terminates in a conventional male power plug 720a which is used to connect the pump to any standard power source sockets. The third segment 718c is connected to the circuit board 742 and is further fastened to the pump control 510 when set in the waterproof potting compound discussed above. In addition, the third segment 718c may be connected to a strain relief bracket attached to the pump 710 to further reduce the risk of damaging the connection between the power cord 718 and the PCB 742 of pump control 510. For example, in the form illustrated in FIGS. 24A-B, the power cord 718 is connected to strain relief bracket 713. The strain relief bracket 713 is designed such that it can be used as a handle to carry the pump 712. The waterproof joint 719 is also designed such that all three segments 718a, 718b, 718c connect to the joint 719 using conventional strain relief connections just in case the waterproof joint 719 is inadvertently used as a handle to lift the pump 712.

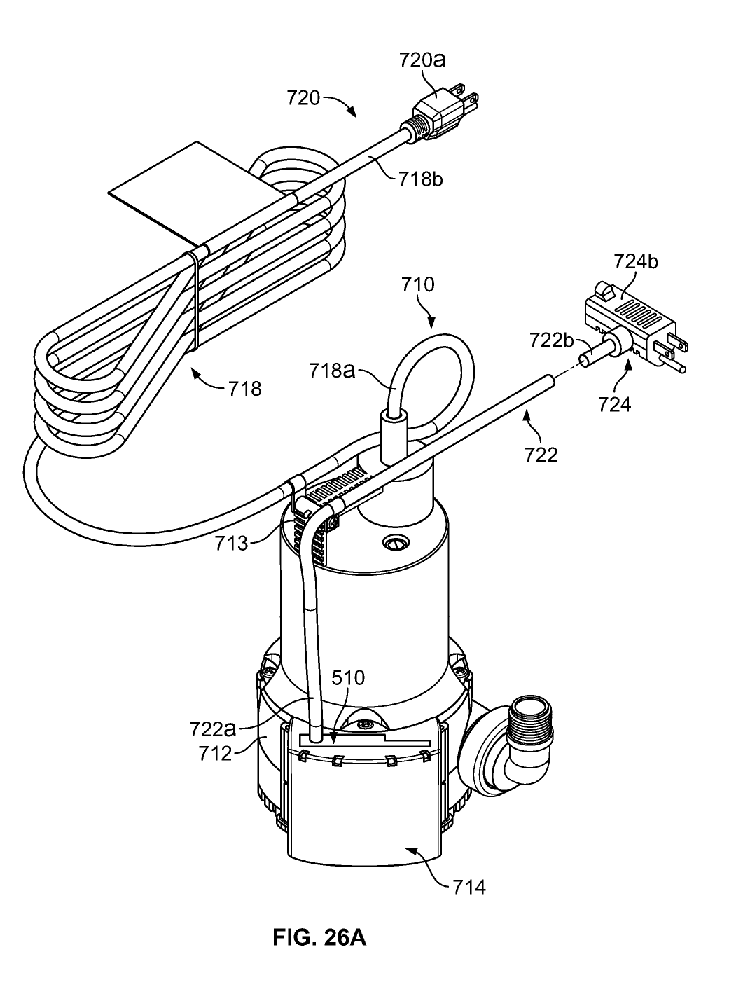

A similar but slightly alternate embodiment of the pump system 710 is illustrated in FIGS. 26A-B. In this embodiment, the system 710 is configured with two power cords 718, 722 in a manner similar to the piggyback configuration discussed with the embodiments above. With this configuration, the power cord 722 of pump control 510 connects between the pump power cord 718 and the power source and switches the pump on and off using switch 560 when high and low fluid levels are reached, respectively. In a preferred form, both power cords 718, 722 will be connected to strain relief 719 to prevent damage being done to the system 710 should it improperly be carried around by either power cord 718, 722.

Although the above mentioned embodiments discuss effective ways in which pump control sensors may be utilized and employed such that the negative effects of the environment within which they operate are minimized, it should be understood that other methods may be used to achieve the same goal. For example, in FIGS. 27A-C, there is illustrated yet other apparatus and methods for cleaning a pump system or its sensors to minimize the negative effects the surrounding environment may have on the pump system or its sensors. In the forms illustrated, the pump itself is used to generate a stream of fluid that is used to keep the pump sensor clean and operating as it should. The apparatus may be implemented so as to clean the entire pump or any of its components, including but not limited to its sensor or sensors. For example, the apparatus can be used to help prevent the mineral buildup problem mentioned above by cleaning the surface of the capacitive sensor so that no salt bridging forms between the electrodes of the capacitor. It should also be understood that such a design could be used or implemented in numerous pump systems including, but not limited to, any of the embodiments discussed above with respect to the capacitor, capacitive sensor, pump control and systems discussed herein.

In FIG. 27A, a single vent or opening 712b is located in and/or defined by the pump chamber or volute of pump 712. The opening 712b is large enough to allow a portion of the fluid being moved or evacuated by the pump to be ejected from the pump housing in a stream. The pump control connected to the housing is connected in such a way as to position the pump sensor in alignment with the fluid stream so that the fluid stream may clean the sensor to assist in keeping the sensor operating properly. In the embodiment illustrated, the pump control housing defines an opening 736f that is aligned with the opening 712b of the pump 712 so that the fluid stream ejected form the opening 712b of pump housing 712 travels directly into the pump control housing 736 and cleans the surfaces of inner wall 736a which defines the cavities that contain PCB 742 and capacitive sensor 514 (see arrows depicting fluid stream and flow of same). This allows the fluid stream to be used to clean the surfaces of the cavities within which the electrodes 738, 740 are disposed to keep these surfaces clear of mineral buildup.

FIG. 27B illustrates an alternate embodiment in which a plurality of fluid streams are used to accomplish the cleaning of the pump system and/or its sensors. More particularly, in this embodiment the pump chamber or volute of pump housing 712 defines two openings 712b, 712c through which fluid streams are ejected from the pump while in operation. Similarly, pump control housing 736 defines two corresponding openings 736f, 736g which are aligned with openings 712b, 712c so that the fluid streams can enter the pump control housing 736 and clean the desired components of the pump system, including but not necessarily limited to electrodes 738, 740.

It also should be understood that the components may be configured and align to allow for the fluid stream to make either direct contact with a desired sensor surface, or indirect contact if so desired (such as may be desired for sensors of a more fragile nature). For example, in FIGS. 27A-B, the electrodes 738, 740 of the capacitive sensor are positioned adjacent the cavity wall on the side opposite the openings 712b, 712c and 736f, 736g through which the fluid stream flows thereby causing the fluid stream to clean the adjacent cavity wall portions via indirect contact. Alternatively, and as illustrated in FIG. 27C, the orientation of the pump control could be switched so that the electrodes 738, 740 of the capacitive sensor are positioned adjacent the cavity wall on the side closes to openings 712b, 712c and 736f, 736g so that the fluid stream makes direct contact with the cavity wall adjacent the electrodes to keep same free from mineral buildup thereby assisting in preventing such buildup from occurring between the electrodes 738, 740.

Although the embodiments of FIGS. 27A-C illustrate the use of the fluid stream with the sensor design of FIGS. 24A-25E, it should also be understood that this concept can be used with any of the sensors discussed herein as well as other sensors and may in fact be used to clean pump components other than sensors.

Although the focus of the discussion thus far has been on apparatus, it should be understood that many methods are also disclosed herein utilizing the inventive concepts set forth above. For example, FIGS. 18-21 also disclose methods of determining fluid levels, methods of determining capacitance, methods of varying capacitance and methods of controlling and operating pumps using same. For example, FIGS. 18-19B disclose a method for reducing the effects of conductive minerals or fluids on a capacitive sensor. In addition, FIG. 21 discloses methods for controlling and operating a pump using a first sensor for activating the pump and a second sensor different from the first for de-activating the pump. FIGS. 21-23 further disclose a method for controlling a pump using a capacitive sensor and/or a current sensor and FIGS. 27A-C further disclose methods for cleaning a pump sensor or system and/or a self cleaning pump sensor or system.

Finally, it should be appreciated that the foregoing merely discloses and describes examples of forms of the present invention. It should therefore be readily recognizable from such description and from the accompanying drawings that various changes, modifications, and variations may be made without departing from the spirit and scope of the present invention. For example, although the drawings show the capacitor and sensor discussed herein being used in a sump pump application, it should be understood that such a capacitor and sensor may be used in a variety of different applications and with a variety of different pieces of equipment including, but not limited to, dewatering, sewage, utility, pool and spa equipment, wired or wireless back-up pump systems, well pumps, lawn sprinkler pumps, condensate pumps, non-clog sewage pumps, effluent and grinder pump applications, water level control applications, as well as other non-pump related applications requiring liquid level control. In still other embodiments, the sensors, pump controls and systems described herein may be setup in an opposite manner to maintain a desired fluid level in an area by detecting when the fluid level has dropped to an undesirably low level and to automatically pump more fluid into the area to maintain the fluid at the desired level. For example, water evaporation is a problem with many pools and spas and often it is necessary to add water to a pool or spa to maintain the water at a desired level. In such cases, the sensors and pump controls described herein can be configured to monitor for a low water level condition and activate a pump to pump in water to maintain the water at the desired level. Similarly, the concepts disclosed herein can be used when dealing with DC motors and circuit applications instead of AC motors and circuit applications. For example, in a battery backup pump application using a DC motor and circuitry, the same capacitor, capacitive sensor and pump controls and/or two sensor systems could be used to operate the pump (albeit some components like triacs may be replace with alternate DC components like transistors).

What is claimed is:

1. A capacitive sensor comprising:
a sensor housing defining a first cavity and a second cavity connected to the first cavity by a bridging member;
a capacitor having a first electrode disposed within the first cavity of the sensor housing and a second electrode disposed within the second cavity of the sensor housing thereby creating a gap between the first and second housing cavities and second electrodes to reduce the risk of mineral buildup between the first and second electrodes; and
a dielectric connecting the first and second electrodes to form a capacitor having a detectable capacitance, the dielectric having a first part made of an insulative material and a second part made of a liquid having a level that changes with respect to the insulative material which causes a change in the capacitance of the capacitor.

2. The capacitive sensor of claim 1 wherein at least a portion of the sensor housing forms at least a portion of the insulative material of the dielectric and the housing is configured such that at least a portion of the first and second cavities may be disposed in the liquid and the bridging member generally remains above the liquid in order to prevent mineral buildup between the capacitor electrodes.

3. The capacitive sensor of claim 2 wherein the first and second cavities are defined by an interior wall having a generally upside down U- or J-shaped cross section and the housing further comprises an exterior wall that surrounds at least a portion of the first and second cavities and is spaced apart from the interior wall that defines the first and second cavities to protect the first and second cavities and any components therein from damage during validation testing or general use of the capacitive sensor.

4. A pump control with internal probes comprising:
a housing defining a first cavity and a second cavity connected via a bridging member;
a controller for actuating a pump connected to a circuit disposed in the housing;
a capacitive sensor connected to the controller via the circuit and having a first electrode probe disposed within the first cavity of the housing and a second electrode probe disposed within the second cavity of the housing thereby creating a gap between the first and second housing cavities and electrodes to reduce the risk of mineral buildup between the first and second electrodes; and
a switch connecting the controller to the pump and operated by the controller for actuating the pump.

5. The pump control of claim 4 wherein the circuit comprises a printed circuit board having a first circuit board portion disposed in the first cavity of the housing to which the first electrode probe is connected and a second circuit board portion disposed in the second cavity of the housing to which the second electrode probe is connected, the circuit board portions being positioned such that the first electrode probe of the capacitor is positioned adjacent an inner surface of the first cavity of the housing and the second electrode probe of the capacitor is positioned adjacent an inner surface of the second cavity of the housing so that when the pump control is immersed in a fluid the portion of the housing adjacent the first and second electrode probes and the fluid within which the pump control is immersed make up at least a portion of the dielectric between the first and second electrode probes of the capacitive sensor to form a capacitor with a detectable capacitance with the bridging member remaining above the fluid to create the gap between the first and second electrode probes.

6. The pump control of claim 5 wherein the first and second cavities are defined by an interior wall and the housing further comprises an exterior wall that surrounds at least a portion of the first and second cavities and is spaced apart from the interior wall that defines the first and second cavities to protect the first and second cavities and any components therein from damage during validation testing or general use of the capacitive sensor.

7. The pump control of claim 5 wherein the first cavity and first circuit board portion are positioned in a lower portion of the housing and the second cavity and second circuit board portion are positioned in an upper portion of the housing so that the second electrode probe is positioned higher than the first electrode probe and the capacitor sensor can be used to detect a high fluid position.

8. The pump control of claim 5 wherein the fluid has a level that changes with respect to the housing which causes a change in the capacitance of the capacitor and the controller actuates the pump when a high fluid position is detected via the capacitive sensor reading a capacitance at or above a predetermined amount.

9. The pump control of claim 8 further comprising a current sensor connected to the controller for monitoring current and shutting off the pump when the current sensor detects a predetermined current reading signifying a low fluid position.

10. A pump system comprising:
a pump having a housing defining an opening within which a motor and impeller are disposed;
a pump control connected to the pump and having:
a pump control housing defining a first cavity and a second cavity connected via a bridging member, the bridging member creating a gap between the first and second housing cavities;
a controller connected to a circuit disposed in the housing for operating the pump;
a capacitive sensor connected to the controller via the circuit and having a first electrode disposed within the first cavity of the pump control housing and a second electrode disposed within the second cavity of the pump control housing so that the electrodes are separated by the gap created by the bridging member to reduce the risk of a mineral buildup occurring between the electrodes;
a current sensor connected to the controller via the circuit; and
a switch connecting the controller to the pump and operated by the controller for operating the pump, the controller activating the pump when the capacitive sensor indicates that a predetermine capacitance has been reached and deactivating the pump when the current sensor indicates that a predetermined current has been reached

11. The pump system of claim 10 wherein the first and second cavities of the pump control housing are defined by an interior wall and the pump control housing further comprises an exterior wall that surrounds at least a portion of the first and second cavities and is spaced apart from the interior wall that defines the first and second cavities to protect the first and second cavities and any components therein from damage during validation testing or general use of the capacitive sensor.

12. The pump system of claim 10 wherein the pump control housing is at least partially disposed in a fluid and the fluid has a level that changes with respect to the pump control housing, the fluid together with at least a portion of the pump control housing forming a dielectric between the first and second electrodes of the capacitive sensor such that the capacitance detected by the capacitive sensor changes with respect to the fluid level and the first and second electrodes are positioned within the pump control housing to detect when a high fluid level has been reached so that the controller will activate the pump to evacuate at least some of the fluid.

13. The pump system of claim 10 wherein the pump has a main power cord and the pump control is connected to the pump via a piggyback power cord that is connected to the switch of the pump control so that the controller can activate the pump when a high fluid level is detected and deactivate the pump when a low fluid level is detected;
the pump further including a strain relief bracket to which both the main power cord and piggyback power cord are connected to prevent movement of either power cord that could damage the power cords connection to the pump or pump control.

14. The pump system of claim 10 wherein the pump and pump control are connected via a power cord and a waterproof joint, the power cord having a first segment that extends from the waterproof joint to the pump to power the pump motor, a second segment that extends from the waterproof joint to a conventional power cord plug for plugging into a conventional power source, and a third segment that extends from the waterproof joint to the switch of the pump control so that the controller can activate the pump when a high fluid level is detected and deactivate the pump when a low fluid level is detected;
the pump further including a strain relief bracket to which the power cord is connected to prevent movement of the power cord segments in such a way that could damage the power cord segments' connection to the pump or pump control.

15. The pump system of claim 14 wherein the power cord segments are connected to the waterproof joint via strain relief connections in case the waterproof joint is used as a handle to carry the pump.

16. A method of controlling a pump comprising:
providing a pump control having a housing defining a first cavity and a second cavity connected by a bridging member;
providing a capacitive sensor for detecting capacitance, the capacitive sensor having a first electrode disposed in the first cavity of the pump control housing and a second electrode disposed in the second cavity of the pump housing, the pump control housing being at least partially disposed in a fluid and the fluid having a level that changes with respect to the pump control housing, the fluid together with at least a portion of the pump control housing forming a dielectric between the first and second electrodes of the capacitive sensor such that the capacitance detected by the capacitive sensor changes with respect to the fluid level and the bridging member being generally located above the fluid to space the first electrode apart from the second electrode and reduce the risk of minerals depositing between the electrodes;
providing a current sensor connected to the pump control for detecting current;
activating the pump via the pump controller when the capacitive sensor detects a high fluid level;
deactivating the pump via the pump controller when the current sensor detects a low fluid level.

17. The method of claim 16 wherein deactivating the pump via the pump controller when the current sensor detects a low fluid level comprises turning off the pump when a predetermined current level has been reached either once or over a plurality of times or when an average of current readings has reached a predetermined current level.

18. The method of claim 17 wherein turning off the pump when a predetermined current level has been reached comprises turning off the pump when a detected current is at or below a predetermined current level.

19. The method of claim 16 further comprising the step of signaling when a pump malfunction has been detected.

20. The method of claim 19 wherein the pump malfunction comprises a high current condition and signaling comprises one or more of the following:
a. cycling on and off the pump via the pump control when the high current condition is detected;
b. actuating a visual and/or audible alarm when the high current condition is detected;
c. transmitting a signal when the high current condition is detected; and
d. disabling or turning off the pump when the high current condition is detected.

21. The method of claim 20 wherein the pump normally operates at a current of 2.5 Amps or less and signaling comprises signaling when the current is at or above 3 Amps.

22. A method of controlling a pump comprising:
providing a pump, a pump control connected to the pump and a first sensor coupled to the pump control to detect high and/or low fluid conditions requiring activation or de-activation of the pump, respectively;
providing a current sensor coupled to the pump control for detecting a real time current at which the pump is operating; and
cycling the pump on and off via the pump control when the real time current at which the pump is operating is higher than a predetermined current in an effort to dislodge any particles that may be clogging the pump and causing the real time current to rise due to a frozen motor condition such as a jammed rotor or an obstructed impeller.

23. A self cleaning pump and pump control system comprising:
a pump housing having a motor and impeller disposed therein, the housing defining an opening through which a fluid may be ejected from the pump housing in a stream;
a pump control connected to the housing and having a sensor positioned in alignment with the fluid stream so that the fluid stream may clean the sensor to assist in keeping the sensor operating properly.

24. A self cleaning pump and pump control system according to claim 23 wherein the pump control has a pump control housing defining a cavity within which the sensor is disposed, the sensor comprising a capacitive sensor having a first electrode positioned adjacent a first portion of the pump control housing and a second electrode positioned adjacent a second portion of the pump control housing so that when the pump control is disposed within a pool of the fluid, the portions of the pump control housing adjacent the first and second electrodes and the pool of fluid make up a dielectric between the first and second electrodes of the capacitive sensor.

25. A self cleaning pump and pump control system according to claim 23 wherein the pump control has a pump control housing defining a cavity within which at least a portion of the sensor is disposed, the sensor comprising a capacitive sensor having a first electrode disposed within the cavity of the pump control housing and a second electrode positioned outside the pump control housing and being spaced apart therefrom thereby creating a gap between the first and second electrodes to reduce the risk of mineral build-up between the first and second electrodes.

26. A self cleaning pump and pump control system according to claim 23 wherein the pump control has a pump control housing defining a first cavity and a second cavity connected via a bridging member, the sensor comprising a capacitive sensor having a first electrode disposed within the first cavity of the pump control housing and a second electrode disposed within the second cavity of the body thereby creating a gap between the first and second housing cavities and electrodes to reduce the risk of mineral buildup between the first and second electrodes.

27. A method of cleaning a pump sensor comprising:
providing a pump housing having a motor and impeller disposed therein, the housing defining an opening through which a fluid may be ejected from the pump housing in a stream;
providing a pump control connected to the housing and having a sensor positioned in alignment with the fluid stream so that the fluid stream may clean the sensor to assist in keeping the sensor operating properly; and
ejecting the fluid stream from the pump housing and onto the sensor to clean the sensor and assist in keeping the sensor operating properly.

28. The method of claim 27 wherein the pump control defines an opening through which the fluid stream may be directed and ejecting the fluid stream from the housing comprises operating the pump motor to rotate the impeller and create movement of the fluid and ejecting the moving fluid from the pump housing and into the opening defined by the pump control.
